(19) United States
(12) Patent Application Publication
(10) Pub. No.: US 2025/0068160 A1
(43) Pub. Date: Feb. 27, 2025

(54) TELEOPERATION ARCHITECTURES FOR AUTONOMOUS SYSTEMS AND APPLICATIONS

(71) Applicant: NVIDIA Corporation, Santa Clara, CA (US)

(72) Inventors: Riccardo Mariani, Porto Azzurro (IT); Gary Hicok, Mesa, AZ (US)

(21) Appl. No.: 18/519,760

(22) Filed: Nov. 27, 2023

(30) Foreign Application Priority Data
Aug. 25, 2023 (IT) 102023000017619

(51) Int. Cl. G05D 1/00; G05D 1/02

(52) U.S. Cl. CPC G05D 1/0077

(57) ABSTRACT

In various examples, teleoperation architectures for safe control of machines are described. Systems and methods are disclosed that use an end-to-end safety architecture that covers both a vehicle or machine and a remote system providing a control center, where the vehicle or machine is at least partly or temporarily configured for control by the remote system. In some examples, the end-to-end architecture uses a layered safety policy monitoring system, where the remote system uses first policies to ensure that operator commands are viable and the vehicle uses second policies to ensure that the operator commands are safe to perform (e.g., will not cause collisions with other objects). Additionally, in some examples, the end-to-end architecture allows for the vehicle to perform minimum risk maneuvers, also referred to as “control fallbacks,” if problems were to occur.

### BACKGROUND

As autonomous vehicles become more prevalent and rely less on direct human control or attention, the autonomous vehicles may be required to navigate environments or situations that are unknown to them without local human input. For example, navigating around pieces of debris in the road, navigating around an accident, crossing into oncoming lanes when a lane of the autonomous vehicle is blocked, navigating through unknown environments or locations, and/or navigating other situations or scenarios may not be possible using the underlying systems of the autonomous vehicles while still maintaining a desired level of safety and/or efficacy.

Some autonomous vehicles, such as those capable of operation at autonomous driving levels 3 or 4 (as defined by the Society of Automotive Engineers (SAE) “Taxonomy and Definitions for Terms Related to Driving Automation Systems for On-Road Motor Vehicles”), include controls for a human operator. As such, conventional approaches to handling the above described situations or scenarios have included handing control back to a passenger of the vehicle. (e.g., a driver). However, for autonomous vehicles of autonomous driving level 5, there may not be a driver, or controls for a driver, so it may not be possible to pass control to a passenger of the autonomous vehicle (or a passenger may be unfit to drive). As another example, the autonomous vehicle may not include passengers (e.g., an empty robo-taxi), or may not be large enough to hold passengers, so control of the autonomous vehicles may be completely self-contained.

Some conventional approaches have provided some level of remote control of autonomous vehicles by using a remote system that projects visualizations onto displays, such as computer monitors or television displays. For instance, the remote system may receive, from an autonomous vehicle, data (e.g., sensor data) representative of an environment for which the autonomous vehicle is navigating. The remote system may then use the data to project the visualizations onto a display associated with a remote operator. While projecting the visualizations, the remote operator may control the autonomous vehicle using control components of a computer, such as a keyboard, mouse, joystick, and/or the like. For example, the remote system may send, to the autonomous vehicle, command messages representative of actions for the autonomous vehicle to perform, where the actions are based on inputs to the control components of the computer.

As such, for a remote system to operate safely, it may be important for the command messages to be accurate and/or the actions to be safe for the autonomous vehicles to perform, the communication systems between the remote system and the autonomous vehicles to be operating and/or uncompromised, latencies associated with the communications between the remote system and the autonomous vehicles to be within a threshold, and/or the autonomous vehicles to still be able to navigate when there are disruptions with the communication systems between the remote system and the autonomous vehicles. However, conventional systems may use different and/or disjoint architectures, such as a first architecture for the remote system and second architectures for the autonomous vehicles, which may cause problems associated with one or more of these safety operations.

### SUMMARY

Embodiments of the present disclosure relate to teleoperation architectures for safe control of machines in autonomous and semi-autonomous systems and applications. Systems and methods are disclosed that use an end-to-end safety architecture that covers both a remote system providing a control center and a vehicle, such as an autonomous vehicle, that is at least partly or temporarily controlled by the remote system. In some examples, the end-to-end architecture uses a layered safety policy monitoring system, where the remote system uses first policies to ensure that operator commands are viable and the vehicle uses second policies to ensure that the operator commands are safe to perform (e.g., will not cause collisions with other objects). Additionally, in some examples, the end-to-end architecture allows for the vehicle to perform minimum risk maneuvers, also referred to as “control fallbacks,” if problems were to occur, such as a disruption in a communication link between the vehicle and the remote system.

In contrast to conventional systems, such as those described above, the current systems, in some embodiments, may use the end-to-end architecture that is substantially symmetrical and/or provides the layered safety policy monitoring system, which increase the overall safety of the current systems. For instance, and as described in more detail herein, since the architecture may be substantially similar for both the remote system and the vehicle, the architecture may be implemented with fewer hardware and/or software stacks (e.g., a single hardware and/or software stack) as compared to the conventional systems, thus resulting in a substantial reduction in design, verification, and/or support. Additionally, in some embodiments, the architecture may implement the layered safety policy monitoring system where the remote system performs first safety checks using first types of policies and the vehicle performs second safety checks using second types of policies, which increases the overall safety as compared to the conventional systems that use disjoint safety architectures. Furthermore, in some embodiments, the architecture may allow for performing minimum risk maneuvers when problems occur, such as a communication link between the remote system and the vehicle being disrupted.

### BRIEF DESCRIPTION OF THE DRAWINGS

The present systems and methods for architectures for safe remote operations of machines in autonomous systems and applications are described in detail below with reference to the attached drawing figures, wherein:

FIG. 1 illustrates an example system that is capable of performing safe remote operations of vehicles or machines within real-world environments, in accordance with some embodiments of the present disclosure;

FIG. 2 illustrates an example of a remote system performing first safety checks associated with a command, in accordance with some embodiments of the present disclosure;

FIG. 3 illustrates an example of a vehicle performing second safety checks associated with a command, in accordance with some embodiments of the present disclosure;

FIG. 4 is a flow diagram showing a method for safely controlling a machine within an environment, in accordance with some embodiments of the present disclosure;

FIG. 5 is a flow diagram showing a method for using an end-to-end architecture to safely control a machine within an environment, in accordance with some embodiments of the present disclosure;

FIGS. 6A-6B are illustrations of systems for remote control of an autonomous vehicle or machine, in accordance with some embodiments of the present disclosure;

FIGS. 7A-7B are illustrations of example virtual environments, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

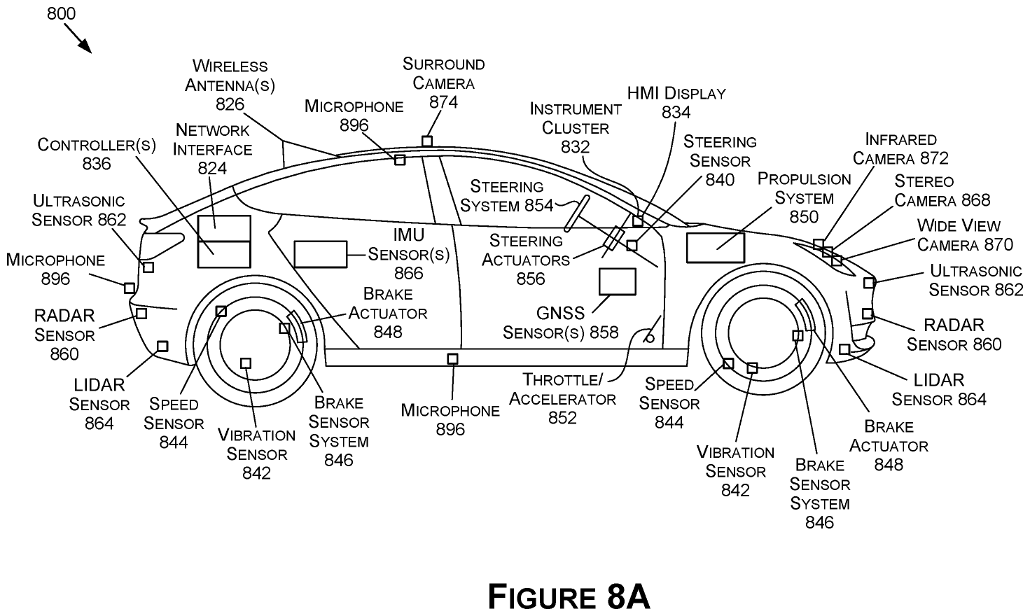

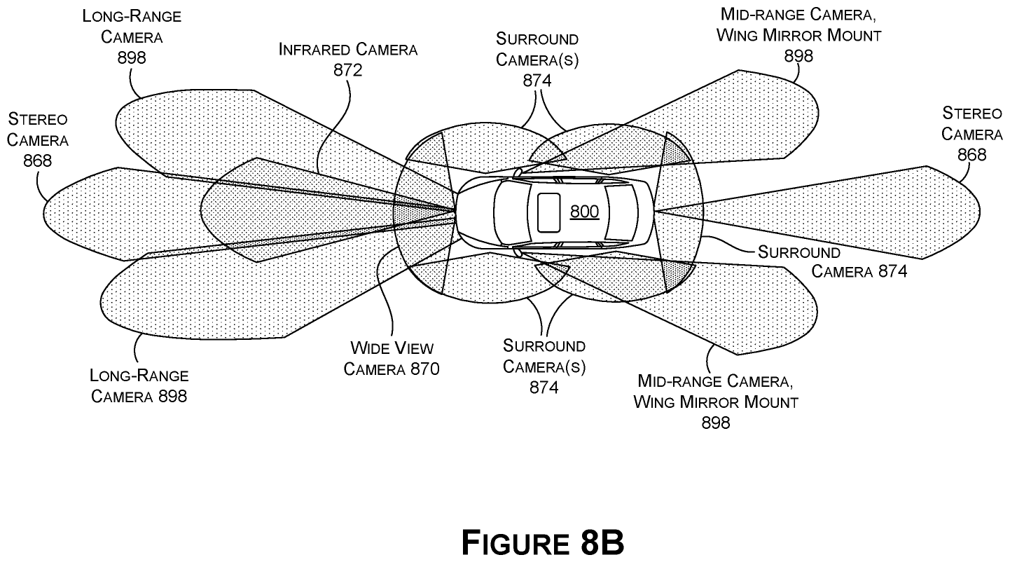

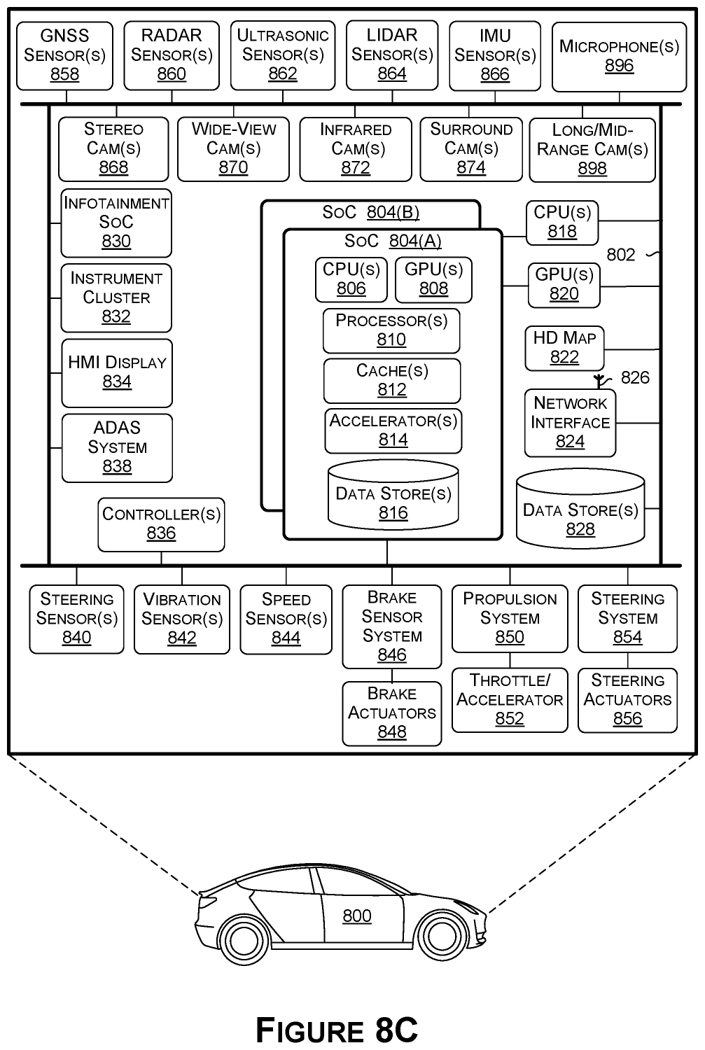

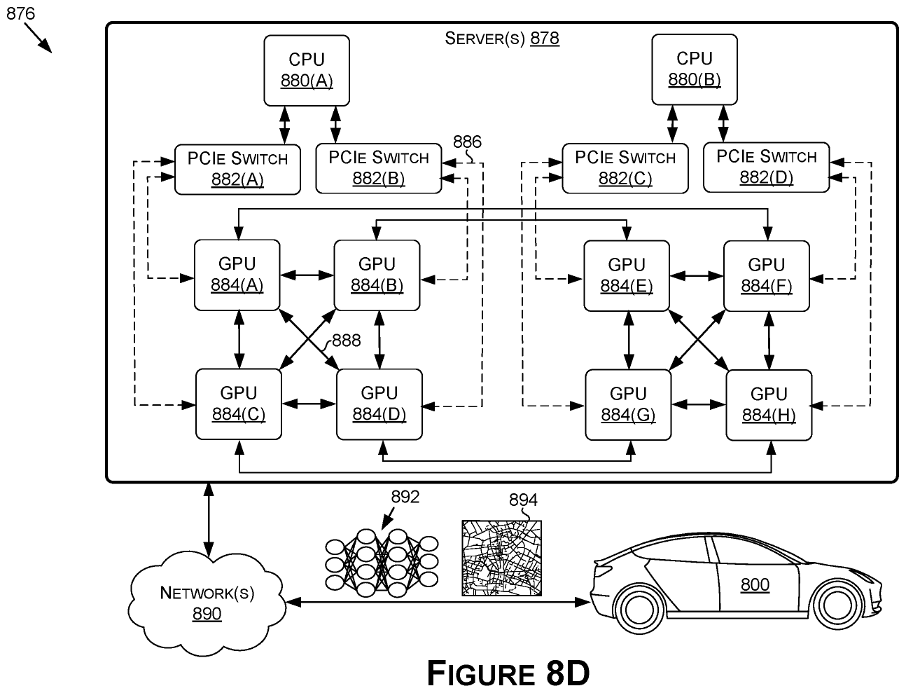

Systems and methods are disclosed related to teleoperation architectures for safe control of machines in autonomous systems and applications. Although the present disclosure may be described with respect to an example autonomous vehicle or machine 800 (alternatively referred to herein as “vehicle 800” or “ego-machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to teleoperation architectures for autonomous machines, this is not intended to be limiting, and the systems and methods described herein may be used in augmented reality, virtual reality, mixed reality, robotics, security and surveillance, autonomous or semi-autonomous machine applications, and/or any other technology spaces where teleoperation may be used.

For instance, a system(s) may use an end-to-end architecture (also referred to as an “architecture”) for remotely controlling vehicles (and/or other types of machines). As described herein, the architecture may provide safety components for a remote system as well as a vehicle or machine, where the safety components are centered around a layered safety policy monitor. For example, the remote system may include a first safety component that is configured to focus at least on command viability and the vehicle may include a second safety component that is configured to focus at least on obstacle detection and avoidance. Additionally, the remote system may include a first sensing component for generating virtual environments, a first planning component for determining actions for the vehicle, and a first action component for generating commands for the actions, while the vehicle includes a second sensing component for generating representations of real-world environments (e.g., a world model based on perception and/or mapping information), a second planning component for interpreting the actions, and a second action component for generating controls for implementing the actions.

For more details, the vehicle may initially use one or more sensors to generate sensor data. As described herein, the sensor data may include, but is not limited to, image data generated using one or more image sensors (e.g., one or more cameras), LIDAR data generated using one or more LIDAR sensors, RADAR data generated using one or more RADAR sensors, inertial measurement unit (IMU) data generated using one or more IMU sensors, and/or any other type of sensor data generated by any other type of sensor. In some examples, the vehicle may then use the second sensing component to generate and/or update a world model associated with the environment, where the world model includes at least information (e.g., classifications, locations, velocities, accelerations, directions of motion, etc.) associated with objects (e.g., roads, traffic signs, other vehicles, pedestrians, structures, etc.) perceived and/or known within the environment.

The vehicle may then use one or more encoders to encode data, such as the sensor data and/or data representing the world model, and send the encoded data to the remote system via one or more networks. In some examples, the vehicle may further encode and/or send additional data to the remote system, such as state data representing a state associated with the vehicle (e.g., wheel angle, steering wheel angle, location, gear, tire pressure, etc.) and/or calibration data associated with the vehicle (e.g., steering sensitivity, braking sensitivity, acceleration sensitivity, etc.). In some examples, such as when the vehicle encodes at least a portion of the data, the remote system may then use one or more decoders to decode the data. The remote system may then use the first sensing component to generate, based at least on the received data, a virtual environment corresponding to the environment for which the vehicle is navigating.

A remote operator may use a view of the virtual environment and/or control components of the remote system to control the vehicle in the physical environment. For example, the remote operator may provide inputs associated with controls, where the controls may include steering, accelerating, braking, and/or the like associated with the vehicle. The remote system may then use at least the first planning component to generate one or more actions associated with the controls. For example, if the inputs include one or more controls that cause the vehicle to change lanes, then the first planning component may generate an action associated with changing lanes. In some examples, the first planning component may further use one or more machine learning models to at least partially help in generating the action(s). For example, if the input from the remote operator just indicates a plan, such as changing lanes, then the first planning component may input data associated with the plan and/or data representing the virtual environment into the machine learning model(s). The machine learning model(s) may then be trained to process the data and, based at least on the processing, output the action (e.g., one or more paths, one or more controls, and/or the like associated with the plan) to be performed.

The remote system may then use the first action component to generate a command to perform the action(s). For example, the command may represent one or more controls for implementing the action. The remote system may also use the first safety component to perform one or more first safety checks associated with the action (e.g., the command). As described herein, the first safety component may be configured to focus on whether the action is viable. For instance, the first safety component may analyze the action using the data received from the vehicle. Based at least on the analysis, the first safety component may determine whether the action satisfies one or more first safety policies. For example, the first safety component may determine whether the action is meaningful in the current driving context (e.g., whether the command will cause the vehicle to navigate to a deadlock situation), whether the action may succeed based on the current driving scenario (e.g., whether the action causes the vehicle to turn where there currently is not a place to turn), whether the action violates agreed boundaries (e.g., whether the action causes the vehicle to violate a driving law), and/or so forth.

If the first safety component determines that the action is not viable, then the remote system may notify the remote operator, receive additional input from the remote operator for an additional action, update the action in order to cause the action to be viable, and/or perform one or more additional and/or alternative processes. However, if the first safety component determines that the action is viable, then the remote system may use one or more encoders to encode data representing a command. The remote system may then send the encoded data to the vehicle.

The vehicle may use one or more decoders in order to decode the encoded data received from the remote system. The vehicle may then use the second planning component to analyze the data in order to interpret the action. In some examples, the second planning component may perform one or more additional processes, such as determining one or more controls for implementing the action. For example, if the action is to change from a current lane to an adjacent lane, then the second planning component may determine the controls needed to perform the lane change, such as controls to turn the vehicle a given amount until the vehicle is located within the adjacent lane. The vehicle may then use the second action component to process the interpreted action and/or the controls. Based at least on the processing, the second action component may cause the vehicle to perform the action.

As discussed herein, such as before the action is performed, the vehicle may use the second safety component to perform one or more safety checks associated with the action and/or the controls. Additionally, as described herein, the second safety component may be configured to focus on obstacle detection and/or avoidance. For example, the second safety component may process the sensor data and/or the world model generated by the second sensing component. Based at least on the processing, the second safety component may determine information associated with the surrounding environment, such as at least the information associated with objects within the environment. The second safety component may then determine whether the vehicle will collide with at least one object located within the environment and/or a likelihood that the vehicle will collide with the at least one object located within the environment. If the second safety component determines that the vehicle will not collide with an object and/or determines that the likelihood is less than a threshold, then the second action component may cause the action to be performed.

However, if the second safety component determines that the vehicle will collide with an object and/or determines that the likelihood is equal to or greater than the threshold, then the vehicle may perform one or more additional processes. For example, the vehicle may determine a new action (e.g., using one or more of the processes described herein), determine one or more new controls for performing the action, notify the remote operator that the action cannot be performed, and/or so forth. As such, the safety components of the end-to-end architecture may work together in order to verify that the actions generated by the remote system and/or the vehicle are viable and safe based on the environment for which the 7ehiclee is navigating. As described herein, by using such an end-to-end architecture to remotely control the vehicle, the overall safety associated with the system(s) may be increased as compared to the conventional systems described above.

In some examples, one or more faults (e.g., problems) may occur with the system(s) (e.g., the end-to-end architecture), such that the vehicle may no longer use commands received from the remote system. For example, a communication link between the vehicle and the remote system may fail, a latency associated with the communication link may increase above a threshold latency, the vehicle may cease receiving commands, the vehicle may no longer be able to send data to the remote system, and/or so forth. In such examples, the vehicle may still be able to determine actions, such as minimum risk maneuvers (also referred to as “control fallbacks”), for the vehicle to perform. For example, the vehicle may use the second planning component to determine one or more actions for the vehicle to perform based at least on the world model generated by the second sensing component and/or the sensor data. In some examples, the action(s) may cause the vehicle to safely stop, such as until the fault(s) associated with the system(s) are no longer occurring. In some examples, the action(s) may cause the vehicle to continue navigating until the fault(s) associated with the system(s) are no longer occurring.

As such, the system(s) described herein may provide for better safety as compared to conventional systems. More specifically, if the first safety component fails, such as due to a problem with hardware and/or software (e.g., not operator error), the second safety component will still avoid unsafe operation of the vehicle. Additionally, based on the layered approach to the safety components, the first safety component (e.g., which may be more complex in terms of policies) may not need a high level of redundancy in design because that level of redundancy is provided by the second safety component that is designed with strict safety principles because it is simpler (e.g., may have less policies).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing light transport simulation, systems for performing collaborative content creation for 3D assets, systems implemented at least partially using cloud computing resources, and/or other types of systems.

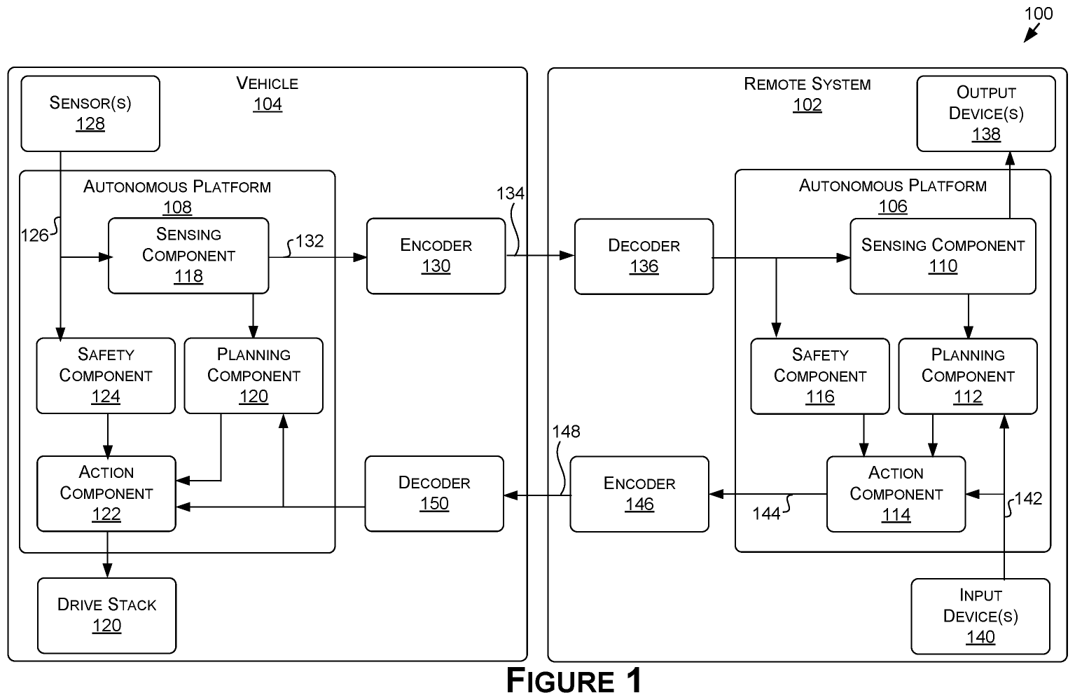

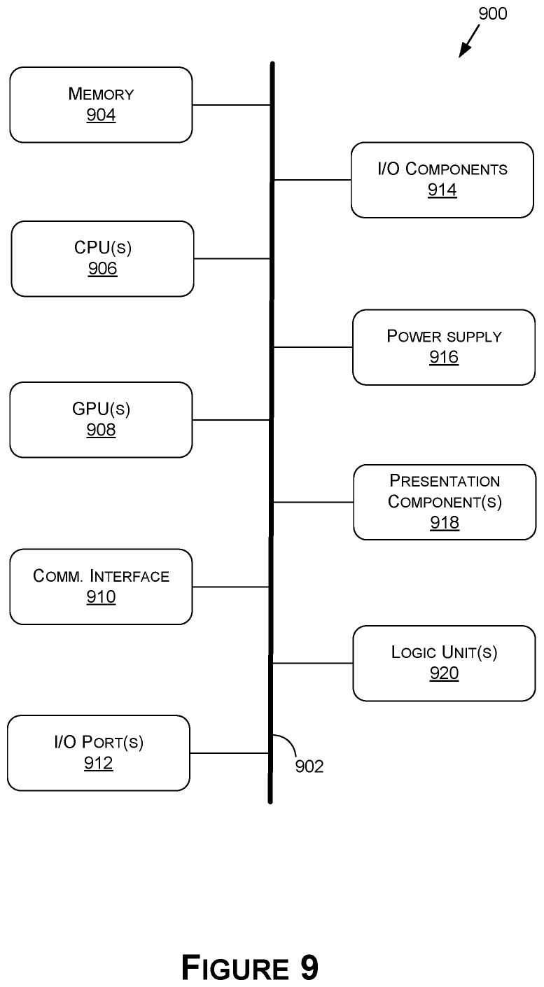

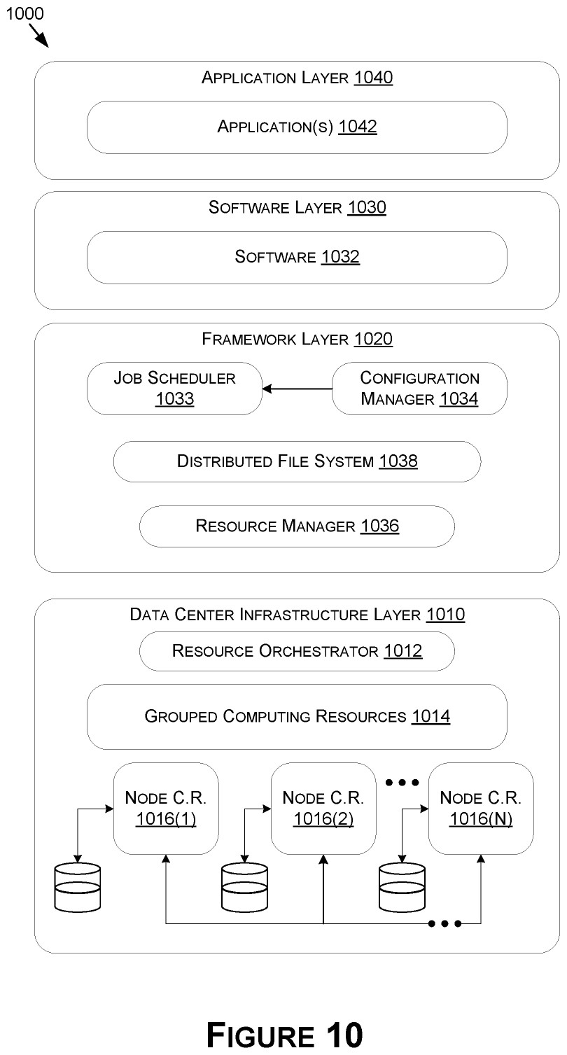

With reference to FIG. 1, FIG. 1 illustrates an example system 100 that is capable of performing safe remote operations of vehicles or machines within real-world environments, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

As shown, the system 100 may include an end-to-end architecture that includes at least one or more remote systems 102 (although only one is illustrated for clarity reasons) and one or more vehicles 104 (although only one is again illustrated for clarity reasons). Additionally, the end-to-end architecture may be substantially symmetric such that an autonomous platform 106 associated with the remote system 102 is similar to an autonomous platform 108 associated with the vehicle 104. For example, the autonomous platform 106 associated with the remote system 102 may include at least a sensing component 110 (e.g., a virtual sensor component), a planning component 112, an action component 114, and a safety component 116, while the autonomous platform 108 associated with the vehicle 104 may include a sensing component 118 (e.g., a real-world sensing component), a planning component 120, an action component 122, and a safety component 124.

As described herein, by using such as a substantially symmetric end-to-end architecture, the end-to-end architecture may be implemented within fewer hardware and/or software stacks (e.g., a single hardware and/or software stack) as compared to the conventional systems, thus resulting in a substantial reduction in design, verification, and/or support. For example, the same (and/or substantially same) hardware and/or software may be used by both the safety component 116 and the safety component 124, but where the safety component 116 is just configured with one or more different policies than the safety component 124. Because of this, there may be a single platform design, a single verification effort, and/or so forth between the safety component 116 and the safety component 124. Additionally, the substantially symmetric end-to-end architecture may increase the safety processing, which is described in more detail herein.

The system 100 may allow for various levels of remote control associated with the vehicle 104 while the vehicle 104 is navigating around one or more environments. For instance, the system 100 may allow for remote driving in which the vehicle 104 is fully under the control of the remote system 102, remote assistance in which the vehicle 104 receives event-driven remote assistance from the remote system 102 while still being responsible for driving tasks, and/or remote monitoring in which the vehicle 104 is remotely monitored by the remote system 102.

As shown, the sensing component 118 of the vehicle 104 may receive sensor data 126 generated using one or more sensors 128. As described herein, the sensor data 126 may include, but is not limited to, image data generated using one or more image sensors (e.g., one or more cameras), LIDAR data generated using one or more LIDAR sensors, RADAR data generated using one or more RADAR sensors, IMU data generated using one or more IMU sensors, and/or any other type of sensor data generated by any other type of sensor.

In some examples, the sensing component 118 may receive the sensor data 126 from the sensor(s) 128 in different formats (e.g., sensors of the same type, such as LIDAR sensors, may output sensor data in different formats), and may be configured to convert the different formats to a uniform format (e.g., for each sensor of the same type). As a result, other components, features, and/or functionality of the vehicle 104, which are described in more detail herein, may use the uniform format, thereby simplifying processing of the sensor data 126. In some examples, the sensing component 118 may use a uniform format to apply control back to the sensor(s) 128 of the vehicle 104, such as to set frame rates or to perform video gain control. The sensing component 118 may also update sensor packets or communications corresponding to the sensor data 126 with timestamps to help inform processing of the sensor data 126 by various components, features, and functionality of the vehicle 104.

In some examples, the sensing component 118 may be used to generate, update, and/or define a world model. In such examples, the sensing component 118 may use information generated by a perception component(s) of a drive stack (which is described herein) and/or the sensing component 118. For instance, the sensing component 118 may include an obstacle perceiver, a path perceiver, a wait perceiver, a map perceiver, and/or other perception component(s). For example, the world model may be defined, at least in part, based on affordances for obstacles, paths, and wait conditions that can be perceived in real-time or near real-time by the obstacle perceiver, the path perceiver, the wait perceiver, and/or the map perceiver. The sensing component 118 may continually update the world model based on newly generated and/or received inputs (e.g., data) from the obstacle perceiver, the path perceiver, the wait perceiver, the map perceiver, and/or other components.

The world model may be used to help inform one or more planning components (e.g., the planning component 120), one or more control components, one or more obstacle avoidance components, one or more safety components (e.g., the safety component 124), and/or one or more actuation components of a drive stack of the vehicle 104, which are described in more detail herein. The obstacle perceiver may perform obstacle perception that may be based on where the vehicle 104 is allowed to drive or is capable of driving, and how fast the vehicle 104 may drive without colliding with an obstacle (e.g., an object, such as a structure, entity, vehicle, etc.) that is sensed by the sensor(s) 128 of the vehicle 104.

The path perceiver may perform path perception, such as by perceiving nominal paths that are available in a particular situation. In some examples, the path perceiver may further take into account lane changes for path perception. A lane graph may represent the path or paths available to the vehicle 104, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information.

The wait perceiver may be responsible to determining constraints on the vehicle 104 as a result of rules, conventions, and/or practical considerations. For example, the rules, conventions, and/or practical considerations may be in relation to traffic lights, multi-way stops, yields, merges, toll booths, gates, police or other emergency personnel, road workers, stopped busses or other vehicles, one-way bridge arbitrations, ferry entrances, etc. In some examples, the wait perceiver may be responsible for determining longitudinal constraints on the vehicle 104 that require the vehicle to wait or slow down until some condition is true. In some examples, wait conditions arise from potential obstacles, such as crossing traffic in an intersection, that may not be perceivable by direct sensing by the obstacle perceiver, for example (e.g., by using the sensor data 126 from the sensor(s) 128, because the obstacles may be occluded from field of views of the sensor(s) 128). As a result, the wait perceiver may provide situational awareness by resolving the danger of obstacles that are not always immediately perceivable through rules and conventions that can be perceived and/or learned. Thus, the wait perceiver may be leveraged to identify potential obstacles and implement one or more controls (e.g., slowing down, coming to a stop, etc.) that may not have been possible relying solely on the obstacle perceiver.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 104 of static or stationary infrastructure objects and obstacles. The map perceiver may also generate information for the wait perceiver and/or the path perceiver, for example, such as to determine which light at an intersection has to be green for the vehicle 104 to take a particular path.

An encoder 130 of the vehicle 104 may encode data 132 generated using the sensing component 118 (e.g., data representing at least a portion of the world model), the sensor data 126 generated using the sensor(s) 128, state data associated with the vehicle 104, and/or additional data. For example, the encoder 130 may be used to convert the data from a first format to a second format, such as a compressed, down sampled, and/or lower data size format than the first format. In such an example, the first format may be a raw format, a lossless format, and/or another format that includes more data (e.g., for image data, the first format may include a raw image format, that may include enough data to fully represent each frame of video). The second format may be in a format that includes less data, such as a lossy format and/or a compressed format (e.g., for image data, the second format may be H264, H265, MPEG-4, MP4, Advanced Video Coding High Definition (AVCHD), Audio Video Interleave (AVI), Windows Media Video (WMV), etc.). The data may be compressed to a smaller data size in order to ensure efficient and effective transmission of the data over one or more networks. For instance, once the data is encoded by the encoder 130, a communication component of the vehicle 104 may transmit or send encoded data 134 to the remote system 102. Although the data is described as being transmitted as encoded data 134, this is not intended to be limiting. In some examples, there may not be the encoder 130, and/or at least some of the data may be transmitted in an uncompressed or non-encoded format.

In some examples, once received from the vehicle 104, the encoded data 134 may be decoded by a decoder 136 of the remote system 102. In other examples, the encoded data 134 may be used by the virtual sensing component 110 without decoding. The virtual sensing component 110 may use the data to generate a virtual environment that may represent the environment (e.g., the real-world or physical environment, such as the ground surface, the vehicles, the people or animals, the buildings, the objects, etc.) in the field(s) of view of the sensor(s) 128 of the vehicle 104 (e.g., the camera(s), the LIDAR sensor(s), the RADAR sensor(s), etc.), as well as represent at least a portion of the vehicle 104 (e.g., an interior, an exterior, components, features, displays, instrument panels, etc.) and/or controls of the vehicle 104 (e.g., a virtual steering wheel, a virtual brake pedal, a virtual gas pedal, a virtual blinker, a virtual HMI display, etc.). In some examples, the virtual environment may include virtual representations of portions of the vehicle 104 that may not be visible to a driver or passenger of the vehicle 104 in the real-world environment, such as the wheels at an angle (e.g., corresponding to the angle of the wheels of the vehicle 104 in the real-world environment as determined by the vehicle state data and/or the calibration data), which may be viewable from within a virtual cockpit of the virtual vehicle by making one or more other components of the virtual vehicle fully transparent, semi-transparent (e.g., translucent), or removed from the rendering altogether.

The virtual environment may be generated from any number of vantage points of a remote operator. For instance, in some examples, the virtual environment may be generated from a vantage point within a driver's seat of the virtual vehicle; from within another location within the virtual vehicle; and from a position outside of the virtual vehicle, such as on top of the virtual vehicle, to the side of the virtual vehicle, behind the virtual vehicle, above the virtual vehicle, etc. In some examples, the remote operator may be able to select from any number of different vantage points and/or may be able to transition between different vantage points, even in the same remote control session. For example, the remote operator may start a remote control session from a first vantage point inside the cockpit of the virtual vehicle (e.g., in the driver's seat), and then, when navigating through a tight space or around an obstacle, may transition to a second vantage point outside of the virtual vehicle where the relationship between the tight space or the obstacle and the virtual vehicle may be more clearly visualized. In any example, the desired vantage point of the remote operator may be selectable within the remote control system. The remote operator may be able to set defaults or preferences with respect to vantage points.

The virtual environment may be output to the remote operator using one or more output devices 138 of the remote system 102. For example, a visual representation of the virtual environment may be displayed using one or more displays, audio associated with the virtual environment may be output using one or more speakers, haptic feedback associated with the virtual environment may be output using one or more haptic devices, and/or so forth. The outputting of the virtual environment is described in more detail herein.

The remote operator may use one or more input devices 140 to control the virtual vehicle within the virtual environment. The input device(s) 140 may include a steering component (e.g., a steering wheel and/or one or more other controls for providing steering inputs, such as a keyboard, a joystick, a handheld controller, and/or the like), an acceleration component (e.g., a physical pedal and/or one or more other controls for causing an acceleration, such as a keyboard, a joystick, a handheld controller, a button, etc.), a braking component (e.g., a physical pedal and/or one or more other controls for causing braking, such as a keyboard, a joystick, a handheld controller, a button, etc.), and/or other control components, such as blinker actuators (which may be physical levers, or may be controlled using a keyboard, a joystick, a handheld controller, voice, etc.), a horn, light actuators (such as a button, lever, or knob for turning on and off lights, including driving lights, fog lights, high-beams, etc.), etc. Based on the input device(s) 140 receiving the input(s), the planning component 112 may receive input data 142 representing the input(s).

The planning component 112 may determine one or more actions for the vehicle to perform based at least on the input data 142. For example, if the input data 142 represents one or more controls associated with changing lanes, then an action may include causing the vehicle 104 to change lanes within the real-world environment based at least on the control(s). For a second example, if the input data 142 represents one or more controls associated with passing a stopped vehicle, then an action may include causing the vehicle 104 to pass the stopped vehicle within the real-world environment based at least on the control(s). While these are just a couple examples of actions that may generated by the planning component 112, in other examples, the planning component 112 may generate any other type of action for the vehicle 104 to perform.

In some examples, the planning component 112 may use one or more artificial intelligence (AI) techniques when generating an action. For example, the input data 142 may represent a plan input by the remote operator, such as a task that the remote operator wants to the vehicle 104 to perform (e.g., change lanes, pass another vehicle, stop, make a turn, etc.). The planning component 112 may then process at least the input data 142 and/or the virtual environment using one or more machine learning models (which may be represented by the planning component 112). Based at least on the processing, the machine learning model(s) may generate one or more paths and/or one or more controls for performing an action associated with the plan. For a first example, if the input data 142 represents a plan associated with causing the vehicle 104 to change from a current lane to an adjacent lane, then the machine learning model(s) may process the input data 142 and data associated with the virtual environment. Based at least on the processing, the machine learning model(s) may generate one or more controls for performing an action of changing lanes, such as one or more steering controls, one or more acceleration controls, one or more braking controls, and/or the like. For a second example, if the input data 142 represents a plan associated with causing the vehicle 104 to pass a stopped car located along a current path of the vehicle 104, then the machine learning model(s) may process the input data 142 and data associated with the virtual environment. Based at least on the processing, the machine learning model(s) may generate one or more paths for performing an action of passing the car, such as a first path to pass the car on a right side of the car, a second plan to pass the car on a left side of the car, and/or the like.

The action component 114 may be configured to generate command data 144 representing a command to perform the action. For instance, the action component 114 may process data representing the action and, based at least on the processing, generate the command that the vehicle 104 is able to interpret. In some examples, the command may include one or more controls for executing the action, such as steering directions, velocity controls, acceleration controls, braking controls, and/or so forth.

The safety component 116 may be configured to perform one or more first safety checks associated with the command (and/or the action). As described herein, the safety component 116 may be configured to focus on whether the command is viable. For example, the safety component 116 may analyze the command using the encoded data 134 received from the vehicle 104 (e.g., after the encoded data 134 is decoded by the decoder 136). Based at least on the analysis, the safety component 116 may determine whether the command satisfies one or more first safety policies. For example, the safety component 116 may determine whether the command is meaningful in the current driving context (e.g., whether the command will cause the vehicle 104 to navigate to a deadlock situation), whether the command may succeed based on the current driving scenario (e.g., whether the command causes the vehicle 104 to turn where there currently is not a place to turn), whether the command violates agreed boundaries (e.g., whether the command causes the vehicle 104 to violate a driving law), and/or so forth.

In some examples, the safety component 116 may use one or more safety requirements when monitoring the remote system 102, the actions, and/or the commands. For instance, some safety requirements that the safety component 116 may perform include, but are not limited to, (1) the remote system 102 should implement a watchdog to assure that regular command messages are available, (2) the remote system 102 should implement a real-time supervision system that cares for regular command messages being generated and/or sent, (3) the remote system 102 should implement a concept and a means to validate command messages, (4) the remote system 102 should monitor (e.g., continuously) communication states and implement strategies to cope with network errors or degradation, (5) the remote system 102 should add a hash value that indicates the remote system 102 is a registered and authorized control instance, (6) the remote system 102 should assure that semantically correct command messages are generated and transmitted, (7) the remote system 102 should add a respective confidence level indication to one or more command messages (e.g., each command message) that indicates a confidence in the contents of the respective command messages, (8) the remote system 102 should monitor processing calculations and transmission times, (9) the remote system 102 should monitor calculation capabilities available and detect bottlenecks or serious delays, (10) the remote system 102 should provide a means for monitoring the remote system 102 internal message transmission times, (11) the remote system 102 should perform plausibility checks between received information and other information, (12) the remote system 102 should notify the vehicle 104 when there are timing problems with the remote system 102 and/or the vehicle 104, and/or additional safety requirements.

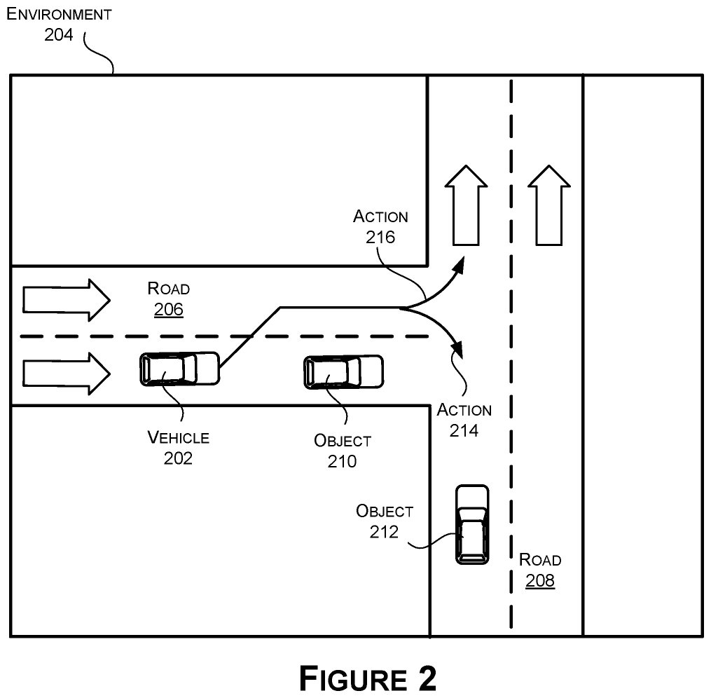

For instance, FIG. 2 illustrates an example of the remote system 102 performing first safety checks associated with a command, in accordance with some embodiments of the present disclosure. As shown, a vehicle 202 (which may represent, and/or include, the vehicle 104) may be navigating around an environment 204 along a first road 206, which includes a one-way road as indicated by the arrows, and approaching a second road 208, which also includes a one-way road as indicated by the arrow. Additionally, a first object 210 may be located on the first road 206 and along the current path of the vehicle 202 and a second object 212 located on the second road 208. In the example of FIG. 2, the first object 210 may be obstructing the path of the vehicle 202. For example, the first object 210 may be unable to move for one or more reasons.

As such, the remote system 102 may initially determine a first command to perform a first action 214 that includes navigating the vehicle 202 around the first object 210 and then turning right onto the second road 208. However, the safety component 116 may analyze the first command and data representing the environment 204 (e.g., data received from the vehicle 202, data representing a virtual environment that corresponds to the environment 204, etc.). Additionally, based at least on the processing, the safety component 116 may determine that the first command is not viable. For example, the safety component 116 may determine that the first command is not viable since the first command would cause the vehicle 202 to violate a driving law, such as navigating in the wrong direction on the second road 208. As such, the safety component 116 may cause the first command to not be performed, such as by causing the remote system 102 to refrain from sending the first command to the vehicle 202.

Additionally, the remote system 102 may determine a second command to perform a second action 216 that includes navigating the vehicle 202 around the first object 210 and then turning left onto the second road 208. The safety component 116 may then analyze the second command and the data representing the environment 204. Additionally, based at least on the processing, the safety component 116 may determine that the second command is viable. For example, the safety component 116 may determine that the second command is meaningful in the current driving context, the second command may succeed based on the current driving scenario, the second command does not violate agreed boundaries, and/or so forth. As such, the safety component 116 may allow the second command to proceed.

Referring back to the example of FIG. 1, based at least on the safety component 116 allowing the command to proceed, an encoder 146 of the remote system 102 may encode the command data 144 from the action component 114. For example, the encoder 146 may be used to convert the data from a first format to a second format, such as a compressed, down sampled, and/or lower data size format than the first format. In such an example, the first format may be a raw format, a lossless format, and/or another format that includes more data. The second format may be in a format that includes less data, such as a lossy format and/or a compressed format. The data may be compressed to a smaller data size in order to ensure efficient and effective transmission of the data over one or more networks. For instance, once the data is encoded by the encoder 146, a communication component of the remote system 102 may transmit or send encoded data 148 to the vehicle 104. Although the data is described as being transmitted as encoded data 148, this is not intended to be limiting. In some examples, there may not be the encoder 146, and/or at least some of the data may be transmitted in an uncompressed or non-encoded format.

In some examples, the encoder 130 may be configured to encode data using a similar format as the encoder 146. However, in other examples, the encoder 130 may be configured to encode at least a portion of the data using a format that differs from a format used by the encoder 146.

In some examples, once received from the remote system 102, the encoded data 148 may be decoded by a decoder 150 of the vehicle 104. In other examples, the encoded data 148 may be used by the vehicle 104 without decoding. In either of the examples, the planning component 120 may be configured to process the command in order to interpret the action associated with the command. For a first example, if the action is associated with changing lanes, then the planning component 120 may be configured to interpret that the command represents the action to change lanes. For a second example, if the action is associated with changing lanes and also includes one or more controls associated with performing the changing of the lanes, then the planning component 120 may be configured to interpret that the command represents the one or more controls for performing the changing of the lanes.

In some examples, the planning component 120 may be configured to perform one or more additional processes associated with the command. For example, the planning component 120 may be configured to use the world model generated by the sensing component 118 in order to determine one or more controls for performing the action within the environment. The control(s) may include, but is not limited to, steering controls (e.g., one or more steering angles), braking controls, acceleration controls, and/or so forth that the vehicle 104 is to perform when executing the action associated with the command. In other words, the remote system 102 may be configured to determine a high-level action for the vehicle 104 to perform and then the vehicle 104 may be configured to determine the low-level controls for executing the action within the real-world environment.

The action component 122 may be configured to cause the vehicle 104 to perform the action using one or more drive components 152 of the vehicle 104. As described herein, the drive component(s) 152 may include, but is not limited to, a steering component, a braking component, an acceleration component, and/or any other component that the vehicle 104 may use when navigating. For example, the action component 122 may cause the drive component(s) 152 to control the vehicle 104 to travel within the real-world environment according to the action and/or the one or more controls associated with the action. Techniques for causing the vehicle 104 to navigate within the real-world environment are described in more detail herein.

As further illustrated in the example of FIG. 1, such as before the action is performed, the safety component 124 may be configured to perform one or more safety checks associated with the action and/or the control(s). As described herein, the safety component 124 may be configured to focus on obstacle detection and/or avoidance. For example, the safety component 124 may analyze the sensor data 126 and/or the world model generated by the sensing component 118. Based at least on the processing, the safety component 124 may determine information associated with the surrounding environment, such as at least information associated with objects located within the environment. The safety component 124 may then determine whether the vehicle 104 will collide and/or a likelihood that the vehicle 104 will collide with at least one object located within the environment when performing the action. If the safety component 124 determines that the vehicle 104 will not collide with an object and/or determines that the likelihood is less than a threshold, then the action component 122 may cause the action to be performed. However, if the safety component 124 determines that the vehicle 104 will collide with an object and/or determines that the likelihood is equal to or greater than the threshold, then the vehicle 104 may refrain from performing the action.

In some examples, the safety component 124 may use one or more safety requirements when monitoring the vehicle 104, the actions, and/or the commands. For instance, some safety requirements that the safety component 124 may perform include, but are not limited to, (1) the vehicle 104 should monitor when a last command message is received and move to a fail operational state (e.g., reduce speed) when a first threshold time period is reached or safely stop when a second threshold time period is reached, (2) the vehicle 104 should check command messages for correctness (e.g., a checksum) and/or authenticity (e.g., using a key associated with the remote system 102), (3) the vehicle 104 should monitor (e.g., continuously) communication states and implement strategies to cope with network errors and/or degradation, (4) if the vehicle 104 ignores a command message that is necessary for operating the vehicle 104, then the vehicle 104 should enter a safe state (e.g., safely stop), (5) the vehicle 104 should keep a confidence threshold for the internal sensor(s) 128 and determine whether to use the sensor data 126 based on the confidence threshold, (6) the vehicle 104 should enter a safe state or degrade function based on receiving information about timing problems from the remote system 102, (7) the vehicle 104 should monitor (e.g., constantly) the computation performance of the real-time computation system, (8) the vehicle 104 should enter a safe state and/or degrade function based on reported network problems, (9) the vehicle 104 should monitor (e.g., constantly) calculation capabilities and detect bottlenecks or serious delays, (10) the vehicle 104 should provide a means for monitoring internal message transmission times, and/or so forth.

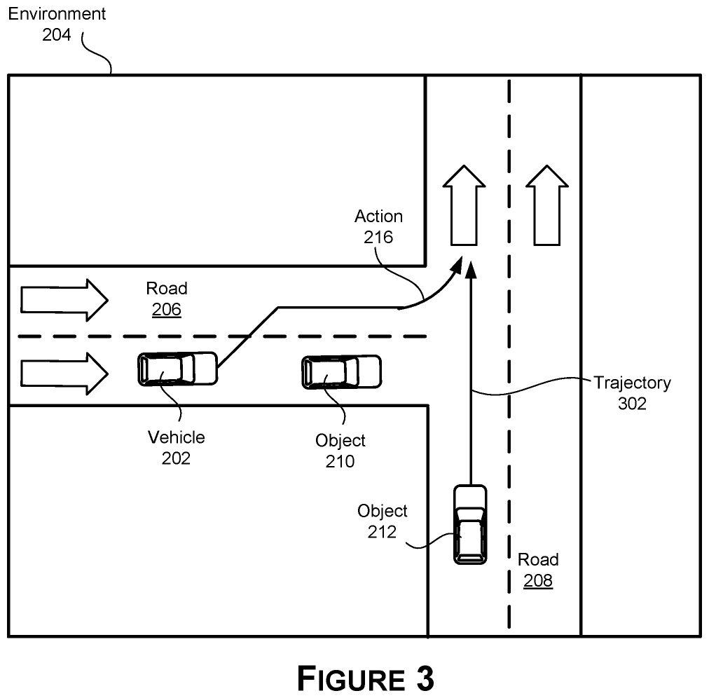

For instance, FIG. 3 illustrates an example of the vehicle 104 performing second safety checks associated with a command, in accordance with some embodiments of the present disclosure. As shown, the safety component 124 may analyze the second action 216 determined by the remote system 102 for the vehicle 202 to perform. For instance, the safety component 124 may determine whether the vehicle 202 will collide with one or more of the objects 210 and 212 and/or whether a likelihood that the vehicle will collide with one or more of the objects 210 and 212 satisfies (e.g., is equal to or greater than) a threshold likelihood. For example, and in the example of FIG. 2, the safety component 124 may determine that a likelihood of collision between the vehicle 202 and the second object 212 satisfies the threshold likelihood based on the second action 216 and a predicted trajectory 302 of the second object 212. Based at least on that determination, the safety component 124 may cause the vehicle 202 to not perform the second action 216.

As such, and in the examples of FIGS. 2 and 3, the safety component 116 may initially determine whether actions are viable within the environment 204 and the safety component 124 may then determine whether the actions are safe to perform within the environment 204. By using the end-to-end architecture that includes such as layered safety policy monitoring system, the overall safety of the system 100 may be increased as compared to conventional systems that use different and/or disjoint architectures.

Referring back to the example of FIG. 1, in some examples, there may be one or more faults associated with the system 100. As described herein, the fault(s) may include, but is not limited to, (1) the remote system 102 not generating command messages when command messages should be generated, (2) the remote system 102 generating command messages when command messages should not be generated, (3) the remote system 102 generating faulty or inaccurate command messages, (4) command messages are lost during transmission to the vehicle 104, (5) command messages are corrupted during transmission to the vehicle 104, (6) command messages are not processed correctly by the vehicle 104, (7) information received by the vehicle 104 is not consistent with sensor information associated with the vehicle 104, (8) the remote system 102 takes too long to generate command messages (e.g., take longer than a threshold period of time), (9) a latency associated with sending the command messages from the remote system 102 to the vehicle 104 exceeds a threshold latency, (10) processing of the command messages by the vehicle 104 exceeds a threshold period of time, (11) the sensor(s) 128 of the vehicle 104 is not operating properly (e.g., the sensor(s) 128 is not generating sensor data 126, the sensor(s) 128 is generating inaccurate sensor data 126, etc.), (12) the data sent from the vehicle 104 to the remote system 102 is interrupted or degraded (e.g., the encoding is not working properly), (13) the data sent from the vehicle 104 to the remote system 102 is lost during transmission, (14) the data received by the remote system 102 is incorrectly decoded by the remote system 102, (15) a time that it takes for the vehicle 104 to encode the data exceeds a threshold period of time, (16) a time for displaying the virtual environment by the remote system 102 exceeds a threshold period of time, and/or so forth.

In some examples, based on the safety component 116 and/or the safety component 124 detecting a fault associated with the system 100, the vehicle 104 may determine one or more actions for the vehicle 104 to perform. For example, the planning component 120 may process the world model generated by the sensing component 118 and/or the sensor data 126 generated using the sensor(s) 128 to determine the action for the vehicle 104 to perform. In some examples, the action(s) may include a minimum risk maneuver, such as a maneuver that causes the vehicle 104 to safely stop. The safety component 124 may then perform one or more of the processes described herein to determine whether the action(s) determined by the planning component 120 is safe to perform. If the safety component 124 determines that the action(s) is not safe, then the safety component 124 may again not let the action(s) to be performed by the vehicle 104. However, if the safety component 124 determines that the action(s) is safe, then the action component 122 may perform one or more of the processes described herein to cause the vehicle 104 to perform the action(s).

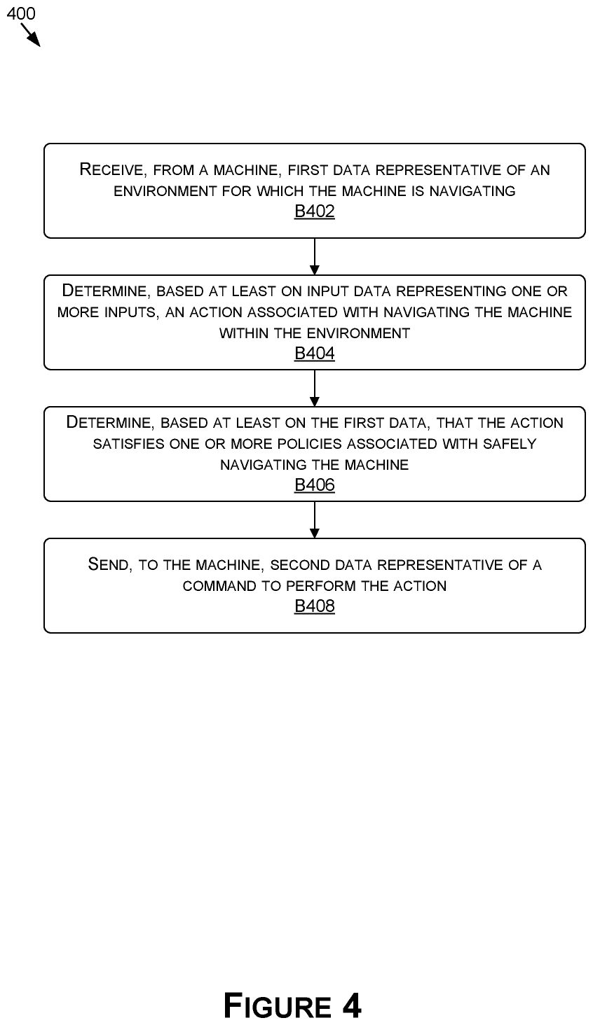

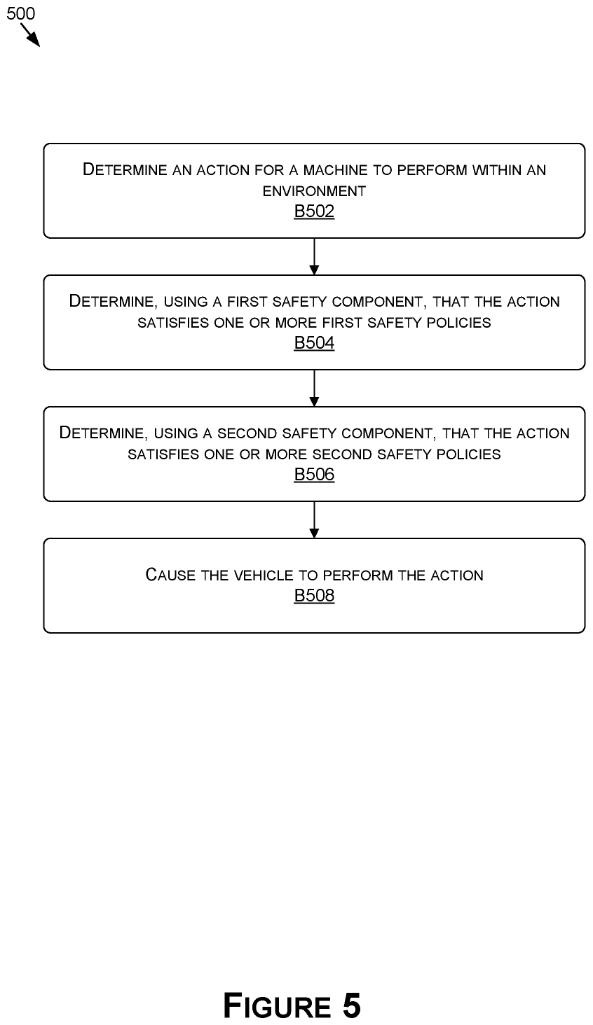

Now referring to FIGS. 4 and 5, each block of methods 400 and 500, described herein, comprises a computing process that may be performed using any combination of hardware, firmware, and/or software. For instance, various functions may be carried out by a processor executing instructions stored in memory. The methods 400 and 500 may also be embodied as computer-usable instructions stored on computer storage media. The methods 400 and 500 may be provided by a standalone application, a service or hosted service (standalone or in combination with another hosted service), or a plug-in to another product, to name a few. In addition, the methods 400 and 500 are described, by way of example, with respect to FIG. 1. However, these methods 400 and 500 may additionally or alternatively be executed by any one system, or any combination of systems, including, but not limited to, those described herein.

FIG. 4 is a flow diagram showing a method 400 for safely controlling a machine within an environment, in accordance with some embodiments of the present disclosure. The method 400, at block B402, may include receiving, from a machine, first data representative of an environment for which the machine is navigating. For instance, the remote system 102 may receive, from the vehicle 104 (e.g., the machine), the encoded data 134 (and/or the data 132 if the vehicle 104 does not encode the data 132). As described herein, the encoded data 134 may include, but is not limited to, at least a portion of the sensor data 126, data representing at least a portion of the world model generated using the sensing component 118, state data associated with the vehicle 104, and/or any other data. In some examples, the remote system 102 may continuously receive the encoded data 134 from the vehicle 104. In some examples, the remote system 102 may receive the encoded data 134 based on the remote operator controlling the vehicle 104.

The method 400, at block B404, may include determining, based at least on input data representative of one or more inputs, an action associated with navigating the machine within the environment. For instance, the remote system 102 (e.g., the planning component 112) may receive the input data 142 representing the input(s) from the remote operator. The remote system 102 may then determine the action based at least on the input data 142. As described herein, in some examples, the input data 142 may represent the controls associated with the action. However, in some examples, the input data 142 may represent a plan associated with the vehicle 104. The remote system 102 may then use one or more machine learning models to determine an action associated with the plan, such as the one or more controls associated with implementing the plan from the remote operator.

The method 600, at block B406, may include determining, based at least on the first data, that the action satisfies one or more policies associated with safely navigating the machine. For instance, the remote system 102 (e.g., the safety component 116) may be configured to focus on whether a command associated with the action is viable. For example, the remote system 102 may analyze the command using at least the encoded data 134 received from the vehicle 104 (e.g., after the encoded data 134 is decoded by the decoder 136). Based at least on the analysis, the remote system 102 may determine that the command satisfies the one or more first safety policies. For example, the remote system 102 may determine that the command is meaningful in the current driving context, that the command may succeed based on the current driving scenario, that the command does not violate agreed boundaries, and/or so forth.

The method 400, at block B408, may include sending, to the machine, second data representative of a command to perform the action. For instance, based at least on determining that the action satisfies the one or more policies, the remote system 102 may send the command data 144 (and/or the encoded data 148) to the vehicle 104. As described herein, the vehicle 104 (e.g., the safety component 124) may be configured to further analyze the action using one or more second safety policies. Based at least on the vehicle 104 determining that the action satisfies the one or more second policies, the vehicle 104 may perform the action.

FIG. 5 is a flow diagram showing a method 500 for using an end-to-end architecture to safely control a machine within an environment, in accordance with some embodiments of the present disclosure. The method 500, at block B502, may include determining an action for a machine to perform within an environment. For instance, the remote system 102 (e.g., the planning component 112) may receive the input data 142 representing the input(s) from the remote operator. The remote system 102 may then determine the action based at least on the input data 142. As described herein, in some examples, the input data 142 may represent the controls associated with the action. However, in some examples, the input data 142 may represent a plan associated with the vehicle 104. The remote system 102 may then use one or more machine learning models to determine an action associated with the plan, such as the one or more controls associated with implementing the plan from the remote operator.

The method 500, at block B504, may include determining, using a first safety component, that the action satisfies one or more first safety policies. For instance, the remote system 102 (e.g., the safety component 116) may be configured to focus on whether a command associated with the action is viable. For example, the remote system 102 may analyze the command using at least the encoded data 134 received from the vehicle 104 (e.g., after the encoded data 134 is decoded by the decoder 136). Based at least on the analysis, the remote system 102 may determine that the command satisfies the one or more first safety policies. For example, the remote system 102 may determine that the command is meaningful in the current driving context, that the command may succeed based on the current driving scenario, that the command does not violate agreed boundaries, and/or so forth.

The method 500, at block B506, may include determining, using a second safety component, that the action satisfies one or more second safety policies. For instance, the vehicle 104 (e.g., the safety component 124) may be configured to perform one or more safety checks associated with the action and/or the controls. As described herein, the vehicle 104 may be configured to focus on obstacle detection and/or avoidance. For example, the vehicle 104 may analyze the sensor data 126 and/or the world model generated by the sensing component 118. Based at least on the processing, the vehicle 104 may determine information associated with the surrounding environment, such as at least information associated with objects located within the environment. The vehicle 104 may then determine that the vehicle 104 will not collide with an object when performing the action and/or that a likelihood that the vehicle 104 will collide with an object located within the environment when performing the action is less than a threshold.

The method 500, at block B508, may include causing the vehicle to perform the action. For instance, based at least on the action satisfying the one or more first policies and the one or more second policies, the vehicle 104 may perform the action within the environment.

With reference to FIGS. 4A-4B, FIGS. 4A-4B are block diagrams of an example autonomous vehicle control system 400 (which may represent, and/or include, the system 100), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

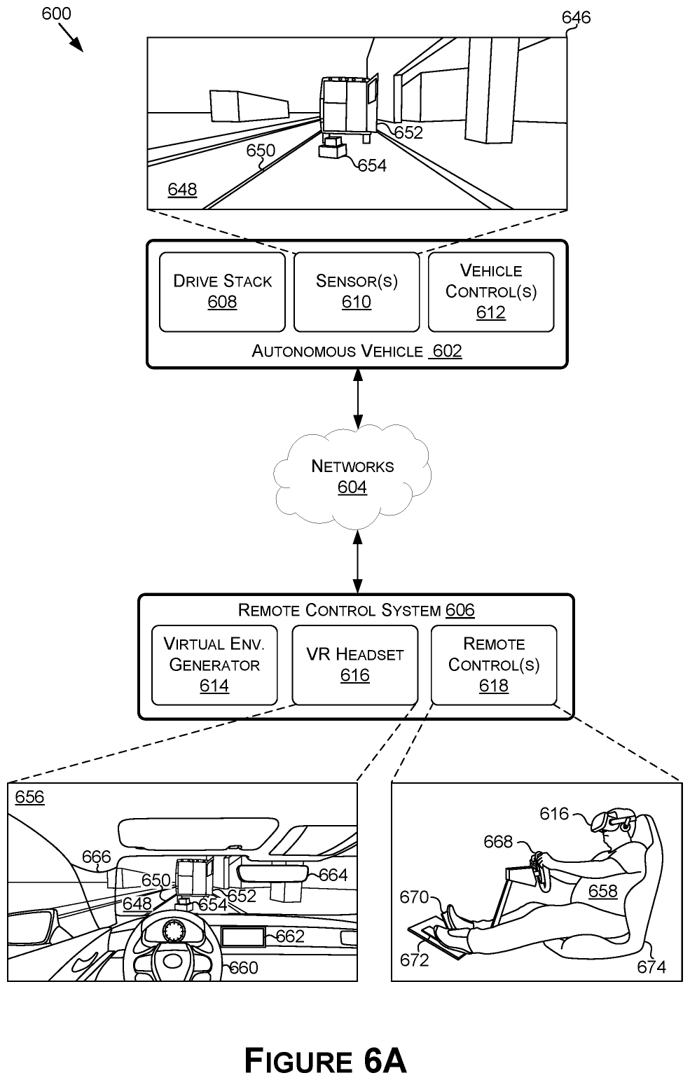

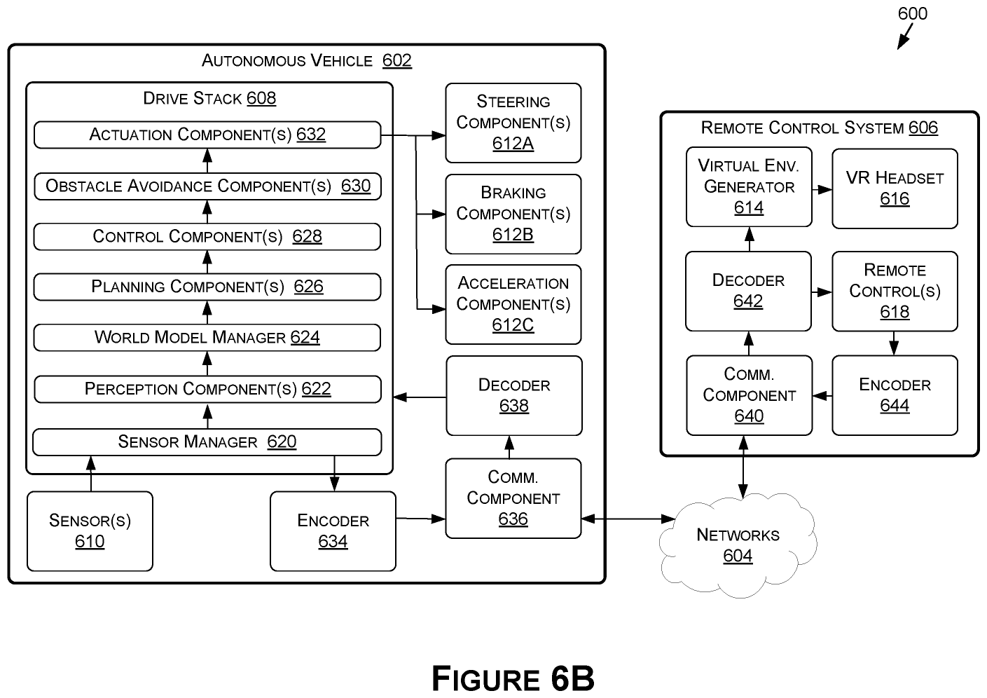

The illustration of FIG. 6A may represent a more generalized illustration of the autonomous vehicle control system 600 as compared to the illustration of FIG. 6B. The components, features, and/or functionality of an autonomous vehicle 602 (which may represent, and/or include, the vehicle 104) described with respect to FIGS. 6A-6B may be implemented using the features, components, and/or functionality described in more detail herein with respect to FIGS. 8A-8D. In addition, as described herein, the components, features, and/or functionality of the autonomous vehicle 602 and/or remote control system 606 (which may represent, and/or include, the remote system 102) described with respect to FIGS. 6A-6B may be implemented using the features, components, and/or functionality described in more detail herein with respect to example computing device 900 of FIG. 9.

The autonomous vehicle control system 600 may include the autonomous vehicle 602, one or more networks 604, and the remote control system 606. The autonomous vehicle 602 may include a drive stack 608, sensors 610, and/or vehicle controls 612. The drive stack 608 may represent an autonomous driving software stack, as described in more detail herein with respect to FIG. 6B. The sensor(s) 610 may include any number of sensors of the vehicle 602, including, with reference to FIGS. 8A-8D, global navigation satellite system (GNSS) sensor(s) 758, RADAR sensor(s) 760, ultrasonic sensor(s) 762, LIDAR sensor(s) 764, inertial measurement unit (IMU) sensor(s) 766, microphone(s) 796, stereo camera(s) 768, wide-view camera(s) 770, infrared camera(s) 772, surround camera(s) 774, long range and/or mid-range camera(s) 798, and/or other sensor types. The sensor(s) 610 may generate sensor data (e.g., image data) representing a field(s) of view of the sensor(s) 610.

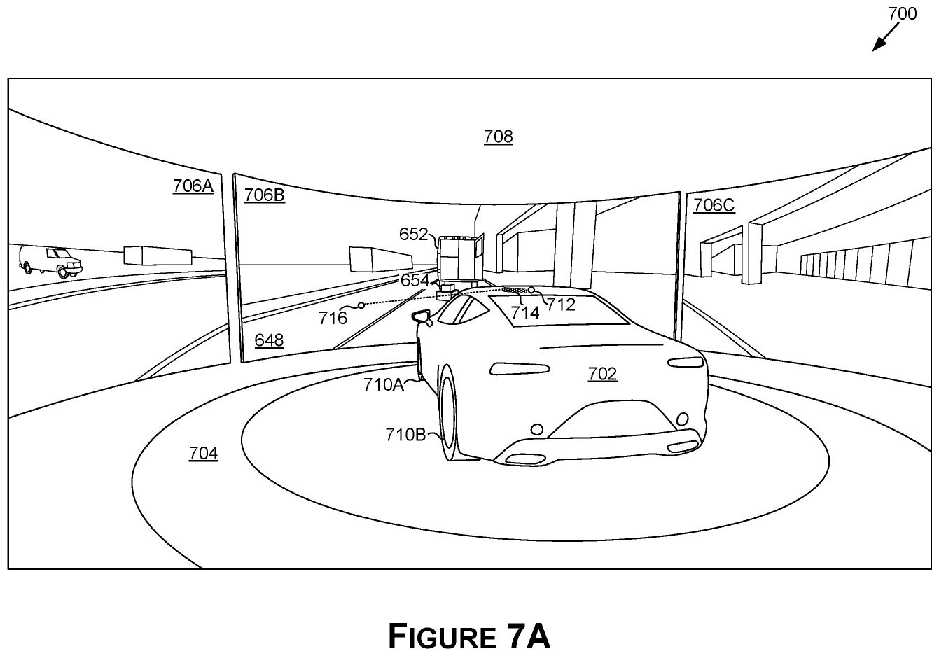

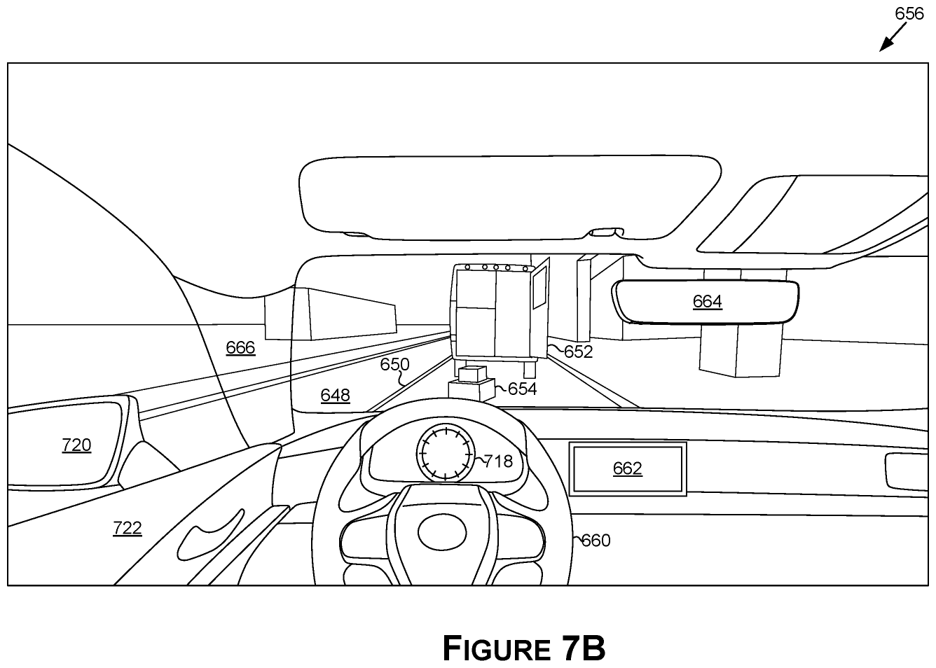

For example, the sensor data may represent a field of view of each of a number of cameras of the vehicle 602. In some examples, the sensor data may be generated from any number of cameras that may provide a representation of substantially 360 degrees around the vehicle 602 (e.g., fields of view that extend substantially parallel to a ground plane). In such an example, the fields of view may include a left side of the vehicle 602, a rear of the vehicle 602, a front of the vehicle 602, and/or a side of the vehicle 602. The sensor data may further be generated to include fields of view above and/or below the vehicle 602 (e.g., of the ground or driving surface around the vehicle 602 and/or of the space above the vehicle 602). In some examples, the sensor data may be generated to include blind spots of the vehicle 602 (e.g., using wing-mirror mounted camera(s)). As another example, the sensor data may be generated from some or all of the camera(s) illustrated in FIG. 7B. As such, the sensor data generated by the vehicle 602 may include sensor data from any number of sensors without departing from the scope of the present disclosure.

With reference to FIG. 6A, an image 646 may include a representation of sensor data (e.g., image data) generated from a front-facing camera of the vehicle 602. The image 646 may include a two-way, solid-line 650 divided street 648, such that the vehicle 602, when following the rules of the road, may not be allowed to cross the solid-line 650 to pass a vehicle or object in the lane of the vehicle 602. In the image 646, a van 652 may be stopped in the lane of the vehicle 602 to unload boxes 654, so the vehicle 602 may have come to a stop a safe distance behind the van 652. By following the constraints of the vehicle 602 (e.g., due to the rules of the road), the vehicle 602 may, without the features and functionality of the present disclosure, remain stopped behind the van 652 until the van 652 moves (or may pass control to a human operator, depending on the embodiment). However, in the current autonomous vehicle control system 600, the vehicle 602 may determine, in response to encountering the situation represented in the image 646, to transfer at least partial control to the remote control system 606. In other examples, the determination to transfer the control of the vehicle 602 (e.g., to initiate a remote control session) may be made by the remote operator (or otherwise may be made at the remote control system 606); by a passenger of the vehicle 602 (e.g., using a command or signal, such as a voice command, an input to a user interface element, a selection of a physical button, etc.); and/or by another actor. For example, sensor data may be analyzed at the remote control system 606 (and/or by another system remote from the vehicle 602) and may be used to determine whether a remote control session should be initiated.

Although the situation represented in FIG. 6A includes a van 652 blocking the lane of the vehicle 602, this is not intended to be limiting. For example, any number of situations, scenarios, and/or environments, including but not limited to those described herein, may lead to a determination by the vehicle 602 to transfer at least partial control to the remote control system 606 without departing from the scope of the present disclosure. In other examples, the determination may be made by the remote control system 606 to take over control of the vehicle 602. In any examples, proper consent may be obtained from the owner and/or operator of the vehicle 602 in order to enable takeover by the remote operator of the remote control system 606.

In addition to the image 646, the vehicle 602 may also capture additional sensor data from additional sensors 610 of the vehicle 602, such as from a side-view camera(s), a rear-view camera(s), a surround camera(s), a wing-mirror mounted camera(s), a roof-mounted camera(s), parking camera(s) (e.g., with a field(s) of view of the ground surface around the vehicle 602), LIDAR sensor(s), RADAR sensor(s), microphone(s), etc. The sensor data generated by the sensor(s) 610 may be transmitted over the network(s) 604 to the remote control system 606. In some examples, the sensor(s) 610 may generate the sensor data in a first format (e.g., a raw format) that may be of a first data size. In order to minimize bandwidth requirements, the sensor data may be encoded in a second format that may be of a second data size less than the first data size (e.g., to decrease the amount of data being sent over the network(s) 604).

In addition to the sensor data that may be used to generate a representation of the environment of the vehicle 602, vehicle state data (e.g., representative of the state of the vehicle 602) and/or calibration data (e.g., for calibrating the remote control(s) 618 according to the vehicle control(s) 612) may also be transmitted over the network(s) 604 to the remote control system 606. For example, the vehicle state data and/or the calibration data may be determined using one or more sensors 610 of the vehicle 602, such as the steering sensor(s) 840, speed sensor(s) 844, brake sensor(s), IMU sensor(s) 866, GNSS sensor(s) 858, and/or other sensors 610. The vehicle state data may include wheel angles, steering wheel angle, location, gear (e.g., Park, Reverse, Neutral, Drive (PRND)), tire pressure, speed, velocity, orientation, etc. The calibration data may include steering sensitivity, braking sensitivity, acceleration sensitivity, etc. In some examples, the calibration data may be determined based on a make, model, or type of the vehicle 602. This information may be encoded in the calibration data by the vehicle 602 and/or may be determined by the remote control system 606, such as by accessing one or more data stores (e.g., after determining identification information for the vehicle 602).

The sensor data, the vehicle state data, and/or the calibration data may be received by the remote control system 606 over the network(s) 604. The network(s) 604 may include one or more network types, such as cellular networks (e.g., 5G, 4G, LTE, etc.), Wi-Fi networks (e.g., where accessible), low power wide-area networks (LPWANs) (e.g., LoRaWAN, SigFox, etc.), and/or other network types. In some examples, the vehicle 602 may include one or more modems and/or one or more antennas for redundancy and/or for communicating over different network types depending on network availability.

The remote control system 606 may include a virtual environment generator 614 (which may represent, and/or include, the sensing component 110), a VR headset 616, and a remote control(s) 618 (which may represent, and/or include, the input device(s) 140). The virtual environment generator 614 may use the sensor data, the vehicle state data, and/or the calibration data to generate a virtual environment that may represent the environment (e.g., the real-world or physical environment, such as the ground surface, the vehicles, the people or animals, the buildings, the objects, etc.) in the field(s) of view of the sensor(s) 610 of the vehicle 602 (e.g., the camera(s), the LIDAR sensor(s), the RADAR sensor(s), etc.), as well as represent at least a portion of the vehicle 602 (e.g., an interior, an exterior, components, features, displays, instrument panels, etc.) and/or controls of the vehicle 602 (e.g., a virtual steering wheel, a virtual brake pedal, a virtual gas pedal, a virtual blinker, a virtual HMI display, etc.). In some examples, the virtual environment may include virtual representations of portions of the vehicle 602 that may not be visible to a driver or passenger of the vehicle 602 in the real-world environment, such as the wheels at an angle (e.g., corresponding to the angle of the wheels of the vehicle 602 in the real-world environment as determined by the vehicle state data and/or the calibration data), which may be viewable from within a virtual cockpit of the virtual vehicle by making one or more other components of the virtual vehicle fully transparent, semi-transparent (e.g., translucent), or removed from the rendering altogether.

The virtual environment may be generated from any number of vantage points of a remote operator. For instance, in some examples, the virtual environment may be generated from a vantage point within a driver's seat of the virtual vehicle (e.g., as illustrated in FIG. 7B); from within another location within the virtual vehicle; and from a position outside of the virtual vehicle (e.g., as illustrated in FIG. 7A), such as on top of the virtual vehicle, to the side of the virtual vehicle, behind the virtual vehicle, above the virtual vehicle, etc. In some examples, the remote operator may be able to select from any number of different vantage points and/or may be able to transition between different vantage points, even in the same remote control session. For example, the remote operator may start a remote control session from a first vantage point inside the cockpit of the virtual vehicle (e.g., in the driver's seat), and then, when navigating through a tight space or around an obstacle, may transition to a second vantage point outside of the virtual vehicle where the relationship between the tight space or the obstacle and the virtual vehicle may be more clearly visualized. In any example, the desired vantage point of the remote operator may be selectable within the remote control system. The remote operator may be able to set defaults or preferences with respect to vantage points.

The remote operator may be able to set defaults and/or preferences with respect to other information in the virtual environment, such as the representations of information that the remote operator would like to have available within the virtual environment, or more specifically with respect to the virtual vehicle in the virtual environment (e.g., the remote operator may select which features of the instrument panel should be populated, what should be displayed on a virtual HMI display, which portions of the vehicle should be transparent and/or removed, what color the virtual vehicle should be, what color the interior should be, etc.). As such, the remote operator may be able to generate a custom version of the virtual vehicle within the virtual environment. In any example, even where the virtual vehicle is not the same year, make, model, and/or type as the vehicle 602 in the real-world environment, the virtual vehicle may be scaled to occupy a substantially similar amount of space in the virtual environment as the vehicle 602 in the real-world environment. As such, even when the virtual vehicle is of a different size or shape as the vehicle 602, the representation of the virtual vehicle may provide a more direct visualization to the remote operator of the amount of space the vehicle 602 occupies in the real-world environment.

In other examples, the virtual vehicle may be generated according to the year, make, model, type, and/or other information of the vehicle 602 in the real-world environment (e.g., if the vehicle 602 is a Year N (e.g. 2019), Make X, and Model Y, the virtual vehicle may represent a vehicle with the dimensions, and steering/driving profiles consistent with a Year N, Make X, Model Y vehicle). In such examples, the remote operator may still be able to customize the virtual vehicle, such as by removing or making transparent certain features, changing a color, changing an interior design, etc., but, in some examples, may not be able to customize the general shape or size of the vehicle.

The virtual environment (e.g., virtual environment 656) may be rendered and displayed on a display of the VR headset 616 of the remote operator (e.g., remote operator 658). The virtual environment 656 may represent a virtual vehicle—that may correspond to the vehicle 602—from a vantage point of the driver's seat. The virtual environment 656 may include a representation of what a passenger of the vehicle 602 may see when sitting in the driver's seat. The camera(s) or other sensor(s) 610 may not capture the sensor data from the same perspective of a passenger or driver of the vehicle. As a result, in order to generate the virtual environment 656 (or other virtual environments where the vantage point does not directly correspond to a field(s) of view of the sensor(s)), the sensor data may be manipulated. For example, the sensor data may be distorted or warped, prior to displaying the rendering on the display of the VR headset 616. In some examples, distorting or warping the sensor data may include performing a fisheye reduction technique on one more of the sensor data feeds (e.g., video feeds from one or more camera(s)). In other examples, distorting or warping the sensor data may include executing a positional warp technique to adjust a vantage point of a sensor data feed to a desired vantage point. In such an example, such as where a camera(s) is roof-mounted on the vehicle 602, a positional warp technique may be used to adjust, or bring down, the image data feed from roof-level of the camera(s) to eye-level of a virtual driver of the virtual vehicle (e.g., the remote operator).

In examples, the sensor data may be manipulated in order to blend or stitch sensor data corresponding to different fields of view of different sensors. For example, two or more sensors may be used to generate the representation of the environment (e.g., a first camera with a first field of view to the front of the vehicle 602, a second camera with a second field of view to a left side of the vehicle 602, and so on). In such examples, image or video stitching techniques may be used to stitch together or combine sensor data, such as images or video, to generate a field of view (e.g., 360 degrees) for the remote operator with virtually seamless transitions between fields of view represented by the different sensor data from different sensors 610. In one or more example embodiments, the sensor data may be manipulated and presented to the remote operator in a 3D visualization (e.g., stereoscopically). For example, one or more stereo cameras 868 of the vehicle 602 may generate images, and the images may be used (e.g., using one or more neural networks, using photometric consistency, etc.) to determine depth (e.g., along a Z-axis) for portions of the real-world environment that correspond to the images. As such, the 3D visualization may be generated using the stereoscopic depth information from the stereo cameras 768. In other examples, the depth information may be generated using LIDAR sensors, RADAR sensors, and/or other sensors of the vehicle 602. In any example, the depth information may be leveraged to generate the 3D visualization for display or presentation to the remote operator within the virtual environment. In such examples, some or all of rendering or display of the virtual environment to the remote operator may include a 3D visualization.

In some examples, because the vehicle 602 may be an autonomous vehicle capable of operating at autonomous driving level 5 (e.g., fully autonomous driving), the vehicle 602 may not include a steering wheel. However, even in such examples, the virtual vehicle may include the steering wheel 660 (e.g., in a position relative to a driver's seat, if the vehicle 602 had a driver's seat) in order to provide the remote operator 658 a natural point of reference for controlling the virtual vehicle. In addition to the steering wheel 660, the interior of the virtual vehicle may include a rear-view mirror 664 (which may be rendered to display image data representative of a field(s) of view of a rear-facing camera(s)), wing mirrors (which may be rendered to display image data representative of field(s) of view of side-view camera(s), wing-mounted camera(s), etc.), a virtual HMI display 662, door handles, doors, a roof, a sunroof, seats, consoles, and/or other portions of the virtual vehicle (e.g., based on default settings, based on preferences of the remote operator, and/or preferences of another user(s) of the remote control system 606, etc.).

As described herein, at least some of the portions of the virtual vehicle may be made at least partially transparent and/or be removed from the virtual environment. An example is support column 666 of the vehicle chassis being at least partially transparent and/or removed from the virtual vehicle, such that objects and the surface in the virtual environment are not occluded or at least less occluded by the support column 666. Examples of the virtual environment 656 are described in more detail herein with respect to FIG. 7B.

The instance of the virtual environment 656 in FIG. 6A (and correspondingly, FIG. 7B) may represent a time that the image 646 was captured by the vehicle 602, and thus may include, as viewed through a windshield of the virtual vehicle, virtual representations of the van 652, the boxes 654, the street 648, and the solid-line 650. In some examples, such as in the virtual environment 656, each of the virtual objects in the virtual environment may be rendered relative to the virtual vehicle to correspond to the relative location of the objects in the real-world environment with respect to the vehicle 602 (e.g., using depth information from the sensor data). The virtual representations of the image data may include the images or video from the image data, rendered within the virtual environment. As described herein, the virtual environment may be rendered from any of a number of different vantage points (including those illustrated in FIGS. 7A-7B), and the virtual environment 656 is only one example of a virtual environment.

The remote operator 658 may use the remote control(s) 618 to control the virtual vehicle in the virtual environment. The remote control(s) 618 may include a steering wheel 668 (or other control(s) for providing steering inputs, such as keyboards, joysticks, handheld controllers, etc.), an acceleration component 670 (which may be a physical pedal as illustrated in FIG. 6A, or may be a keyboard, a joystick, a handheld controller, a button, etc.), a braking component 672 (which may be a physical pedal as illustrated in FIG. 6A, or may be a keyboard, a joystick, a handheld controller, a button, etc.), and/or other control components, such as blinker actuators (which may be physical levers, or may be controlled using a keyboard, a joystick, a handheld controller, voice, etc.), a horn, light actuators (such as a button, lever, or knob for turning on and off lights, including driving lights, fog lights, high-beams, etc.), etc.

In some examples, the remote control(s) may include pointers (e.g., controllers or other objects) that may be used to indicate or identify a location in the environment that the virtual vehicle should navigate to. In such examples, the remote control(s) 618 may be used to provide input to the vehicle 602 as to where in the real-world environment the vehicle 602 should navigate, and the vehicle 602 may use this information to generate controls for navigating to the location. For example, with respect to the image 646, the remote operator 658 may point to a location in the lane to the left of the vehicle 602 and the van 652, such that the vehicle 602 is able to use the information to override the rules of the road that have stopped the vehicle from passing the van 652, and to proceed to the adjacent lane in order to pass the van 652 and the boxes 654. More detail is provided herein for control input types with respect to FIG. 6B.

In any example, the remote operator 658 may control the virtual vehicle through the virtual environment 656, and the control inputs to the remote control(s) 618 may be captured. Control data representative of each of the control inputs (e.g., as they are received by the remote control system 606) may be transmitted to the vehicle 602 over the network(s) 604. In some examples, as described in more detail herein, the control data may be encoded by the remote control system 606 prior to transmission and/or may be encoded upon receipt by the vehicle 602. The encoding may be to convert the control data from the remote control system 606 to vehicle control data suitable for use by the vehicle 602. The control data may be scaled, undergo a format change, and/or other encoding may be executed to convert the control data to vehicle control data that the vehicle 602 understands and can execute. As a result, as the remote operator 658 controls the virtual vehicle through the virtual environment, the vehicle 602 may be controlled through the real-world environment accordingly. With respect to the image 646 and the virtual environment 656, the remote operator 658 may control the virtual vehicle to navigate around the virtual representation of the van 652 by entering the adjacent lane of the street 648 to the left of the van 652, passing the van 652, and then reentering the original lane. Responsive to the input controls from the remote operator 658, the vehicle 602 may, at substantially the same time, navigate around the van 652 by entering the adjacent lane of the street 648 in the real-world environment, proceeding past the van 652, and then reentering the original lane of the street 648.

In some examples, such as depending on the preferences of the owner and/or operator of the vehicle 602, a remote control session may be substantially seamless to any passengers of the vehicle 602, such that the passengers may not be made aware or notice the transfer of control to the remote control system 606 and then back to the vehicle 602. In other examples, further depending on the preferences of the owner and/or operator, the passengers of the vehicle may be informed prior to and/or during the time when the control is passed to the remote control system 606. For example, the remote control system 606 may include a microphone(s) and/or a speaker(s) (e.g., headphones, standalone speakers, etc.), and the vehicle 602 may include a microphone(s) and/or a speaker(s), such that one-way or two-way communication may take place between the passengers and the remote operator 658. In such examples, once control is passed back to the vehicle 602, the passengers may again be made aware of the transition.

Now referring to FIG. 6B, FIG. 6B may include a more detailed illustration of the autonomous vehicle control system 600 of FIG. 6A. The autonomous vehicle 602 may include the drive stack 608 (at least a portion of the drive stack 608 may represent, and/or include, the planning component 120 and/or the action component 122), which may include a sensor manager 620, perception component(s) 622 (e.g., corresponding to a perception layer of the drive stack 608), a world model manager 624, planning component(s) 626 (e.g., corresponding to a planning layer of the drive stack 608), control component(s) 628 (e.g., corresponding to a control layer of the drive stack 608), obstacle avoidance component(s) (e.g., corresponding to an obstacle or collision avoidance layer of the drive stack 608), actuation component(s) 632 (e.g., corresponding to an actuation layer of the drive stack 608), and/or other components corresponding to additional and/or alternative layers of the drive stack 608.

The sensor manager 620 may manage and/or abstract sensor data from sensors 610 of the vehicle 602. For example, and with reference to FIG. 8C, the sensor data may be generated (e.g., perpetually, at intervals, based on certain conditions) by global navigation satellite system (GNSS) sensor(s) 758, RADAR sensor(s) 760, ultrasonic sensor(s) 762, LIDAR sensor(s) 764, inertial measurement unit (IMU) sensor(s) 766, microphone(s) 796, stereo camera(s) 768, wide-view camera(s) 770, infrared camera(s) 772, surround camera(s) 774, long range and/or mid-range camera(s) 798, and/or other sensor types.

The sensor manager 620 may receive the sensor data from the sensors in different formats (e.g., sensors of the same type, such as LIDAR sensors, may output sensor data in different formats), and may be configured to convert the different formats to a uniform format (e.g., for each sensor of the same type). As a result, other components, features, and/or functionality of the autonomous vehicle 602 may use the uniform format, thereby simplifying processing of the sensor data. In some examples, the sensor manager 620 may use a uniform format to apply control back to the sensors of the vehicle 602, such as to set frame rates or to perform video gain control. The sensor manager 620 may also update sensor packets or communications corresponding to the sensor data with timestamps to help inform processing of the sensor data by various components, features, and functionality of the autonomous vehicle control system 600.

A world model manager 624 (which may represent, and/or include, the sensing component 118) may be used to generate, update, and/or define a world model. The world model manager 624 may use information generated by and received from the perception component(s) 622 of the drive stack 608. The perception component(s) 622 may include an obstacle perceiver, a path perceiver, a wait perceiver, a map perceiver, and/or other perception component(s) 622. For example, the world model may be defined, at least in part, based on affordances for obstacles, paths, and wait conditions that can be perceived in real-time or near real-time by the obstacle perceiver, the path perceiver, the wait perceiver, and/or the map perceiver. The world model manager 624 may continually update the world model based on newly generated and/or received inputs (e.g., data) from the obstacle perceiver, the path perceiver, the wait perceiver, the map perceiver, and/or other components of the autonomous vehicle control system 600.

The world model may be used to help inform planning component(s) 626, control component(s) 628, obstacle avoidance component(s) 630, and/or actuation component(s) 632 of the drive stack 608. The obstacle perceiver may perform obstacle perception that may be based on where the vehicle 602 is allowed to drive or is capable of driving, and how fast the vehicle 602 can drive without colliding with an obstacle (e.g., an object, such as a structure, entity, vehicle, etc.) that is sensed by the sensors 610 of the vehicle 602.

The path perceiver may perform path perception, such as by perceiving nominal paths that are available in a particular situation. In some examples, the path perceiver may further take into account lane changes for path perception. A lane graph may represent the path or paths available to the vehicle 602, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information.

The wait perceiver may be responsible to determining constraints on the vehicle 602 as a result of rules, conventions, and/or practical considerations. For example, the rules, conventions, and/or practical considerations may be in relation to traffic lights, multi-way stops, yields, merges, toll booths, gates, police or other emergency personnel, road workers, stopped busses or other vehicles, one-way bridge arbitrations, ferry entrances, etc. In some examples, the wait perceiver may be responsible for determining longitudinal constraints on the vehicle 602 that require the vehicle to wait or slow down until some condition is true. In some examples, wait conditions arise from potential obstacles, such as crossing traffic in an intersection, that may not be perceivable by direct sensing by the obstacle perceiver, for example (e.g., by using sensor data from the sensors 610, because the obstacles may be occluded from field of views of the sensors 610). As a result, the wait perceiver may provide situational awareness by resolving the danger of obstacles that are not always immediately perceivable through rules and conventions that can be perceived and/or learned. Thus, the wait perceiver may be leveraged to identify potential obstacles and implement one or more controls (e.g., slowing down, coming to a stop, etc.) that may not have been possible relying solely on the obstacle perceiver.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 602 of static or stationary infrastructure objects and obstacles. The map perceiver may also generate information for the wait perceiver and/or the path perceiver, for example, such as to determine which light at an intersection has to be green for the vehicle 602 to take a particular path.

In some examples, information from the map perceiver may be sent, transmitted, and/or provided to server(s) (e.g., to a map manager of server(s) 878 of FIG. 8D), and information from the server(s) may be sent, transmitted, and/or provided to the map perceiver and/or a localization manager of the vehicle 602. The map manager may include a cloud mapping application that is remotely located from the vehicle 602 and accessible by the vehicle 602 over the network(s) 604. For example, the map perceiver and/or the localization manager of the vehicle 602 may communicate with the map manager and/or one or more other components or features of the server(s) to inform the map perceiver and/or the localization manager of past and present drives or trips of the vehicle 602, as well as past and present drives or trips of other vehicles. The map manager may provide mapping outputs (e.g., map data) that may be localized by the localization manager based on a particular location of the vehicle 602, and the localized mapping outputs may be used by the world model manager 624 to generate and/or update the world model.

In any example, when a determination is made, based on information from the path perceiver, the wait perceiver, the map perceiver, the obstacle perceiver, and/or another component of the perception component(s) 622, that prevents the vehicle 602 from proceeding through a certain situation, scenario, and/or environment, at least partial control may be transferred to the remote control system 606. In some examples, the passengers of the vehicle 602 may be given an option to wait until the vehicle 602 is able to proceed based on internal rules, conventions, standards, constraints, etc., or to transfer the control to the remote control system 606 to enable the remote operator to navigate the vehicle 602 through the situation, scenario, and/or environment. The remote operator, once given control, may provide control inputs to the remote control(s) 618, and the vehicle 602 may execute vehicle controls corresponding to the control inputs that are understandable to the vehicle 602.

The planning component(s) 626 may include a route planner, a lane planner, a behavior planner, and a behavior selector, among other components, features, and/or functionality. The route planner may use the information from the map perceiver, the map manager, and/or the localization manger, among other information, to generate a planned path that may consist of GNSS waypoints (e.g., GPS waypoints). The waypoints may be representative of a specific distance into the future for the vehicle 602, such as a number of city blocks, a number of kilometers/miles, a number of meters/feet, etc., that may be used as a target for the lane planner.

The lane planner may use the lane graph (e.g., the lane graph from the path perceiver), object poses within the lane graph (e.g., according to the localization manager), and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The behavior planner may determine the feasibility of basic behaviors of the vehicle 602, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) 628 may follow a trajectory or path (lateral and longitudinal) that has been received from the behavior selector of the planning component(s) 626 as closely as possible and within the capabilities of the vehicle 602. In some examples, the remote operator may determine the trajectory or path, and may thus take the place of or augment the behavior selector. In such examples, the remote operator may provide controls that may be received by the control component(s) 628, and the control component(s) may follow the controls directly, may follow the controls as closely as possible within the capabilities of the vehicle, or may take the controls as a suggestion and determine, using one or more layers of the drive stack 608, whether the controls should be executed or whether other controls should be executed.

The control component(s) 628 may use tight feedback to handle unplanned events or behaviors that are not modeled and/or anything that causes discrepancies from the ideal (e.g., unexpected delay). In some examples, the control component(s) 628 may use a forward prediction model that takes control as an input variable, and produces predictions that may be compared with the desired state (e.g., compared with the desired lateral and longitudinal path requested by the planning component(s) 626). The control(s) that minimize discrepancy may be determined.

Although the planning component(s) 626 and the control component(s) 628 are illustrated separately, this is not intended to be limiting. For example, in some embodiments, the delineation between the planning component(s) 626 and the control component(s) 628 may not be precisely defined. As such, at least some of the components, features, and/or functionality attributed to the planning component(s) 626 may be associated with the control component(s) 628, and vice versa.

The obstacle avoidance component(s) 630 may aid the autonomous vehicle 602 in avoiding collisions with objects (e.g., moving and stationary objects). The obstacle avoidance component(s) 630 may include a computational mechanism at a “primal level” of obstacle avoidance that may act as a “survival brain” or “reptile brain” for the vehicle 602. In some examples, the obstacle avoidance component(s) 630 may be used independently of components, features, and/or functionality of the vehicle 602 that is required to obey traffic rules and drive courteously. In such examples, the obstacle avoidance component(s) may ignore traffic laws, rules of the road, and courteous driving norms in order to ensure that collisions do not occur between the vehicle 602 and any objects. As such, the obstacle avoidance layer may be a separate layer from the rules of the road layer, and the obstacle avoidance layer may ensure that the vehicle 602 is only performing safe actions from an obstacle avoidance standpoint. The rules of the road layer, on the other hand, may ensure that vehicle obeys traffic laws and conventions, and observes lawful and conventional right of way (as described herein).

In some examples, when controls are received from the remote control system 606, the obstacle avoidance component(s) 630 may analyze the controls to determine whether implementing the controls would cause a collision or otherwise not result in a safe or permitted outcome. In such an example, when it is determined that the controls may not be safe, or may result in a collision, the controls may be aborted or discarded, and the vehicle 602 may implement a safety procedure to get the vehicle 602 to a safe operating condition. The safety procedure may include coming to a complete stop, pulling to the side of the road, slowing down until a collision is no longer likely or imminent, and/or another safety procedure. In examples, when controls from the remote control system 606 are determined to be unsafe, control by the remote control system 606 may be transferred, at least temporarily, back to the vehicle 602.

In some examples, such as the example in FIG. 6B, the obstacle avoidance component(s) 630 may be located after the control component(s) 628 in the drive stack 608 (e.g., in order to receive desired controls from the control component(s) 628, and test the controls for obstacle avoidance). However, even though the obstacle avoidance component(s) 630 are shown stacked on top of (e.g., with respect to an autonomous driving software stack) the planning component(s) 626 and the control component(s) 628, this is not intended to be limiting. For example, the obstacle avoidance component(s) 630 may be additionally or alternatively implemented prior to either of the planning component(s) 626 or the control component(s) 628, prior to the control component(s) 628 but after the planning component(s) 626, as part of or integral to the planning component(s) 626 and/or the control component(s) 628, as part of one or more of the perception component(s) 622, and/or at a different part of the drive stack 608 depending on the embodiment. As such, the obstacle avoidance component(s) 630 may be implemented in one or more locations within an autonomous vehicle driving stack or architecture without departing from the scope of the present disclosure.

In some examples, as described herein, the obstacle avoidance component(s) 630 may be implemented as a separate, discrete feature of the vehicle 602. For example, the obstacle avoidance component(s) 630 may operate separately (e.g., in parallel with, prior to, and/or after) the planning layer, the control layer, the actuation layer, and/or other layers of the drive stack 608.

The encoder 634 may encode the sensor data from the sensor manager 620 and/or the sensor(s) 610 of the vehicle 602. For example, the encoder 634 may be used to convert the sensor data from a first format to a second format, such as a compressed, down sampled, and/or lower data size format that the first format. In such an example, the first format may be a raw format, a lossless format, and/or another format that includes more data (e.g., for image data, the first format may include a raw image format, that may include enough data to fully represent each frame of video). The second format may be in a format that includes less data, such as a lossy format and/or a compressed format (e.g., for image data, the second format may be H264, H265, MPEG-4, MP4, Advanced Video Coding High Definition (AVCHD), Audio Video Interleave (AVI), Windows Media Video (WMV), etc.). The sensor data may be compressed to a smaller data size in order to ensure efficient and effective transmission of the sensor data over the network(s) 604 (e.g., cellular networks, such as 5G).

Once the sensor data is encoded by the encoder 634, a communication component 636 of the vehicle 602 may transmit or send the encoded sensor data to the remote control system 606. Although the sensor data is described as being transmitted as encoded sensor data, this is not intended to be limiting. In some examples, there may not be an encoder 634, and/or at least some of the sensor data may be transmitted in an uncompressed or non-encoded format.

The remote control system 606 may receive the sensor data at communication component 640 of the remote control system 606. Where a communication is received and/or transmitted as a network communication, the communication component 636 and/or 640 may comprise a network interface which may use one or more wireless antenna(s) and/or modem(s) to communicate over one or more networks. By including one or more modems and/or one or more wireless antennas, the vehicle 602 may be capable of communication across different network types (e.g., Wi-Fi, cellular 4G, LTE, 5G, etc.), and may also have redundancy for when one or more networks may not be available, when one or more networks may not have a strong enough connection to transmit the sensor data, and/or for when one or more of the modems goes offline or stops working. For example, the network interface may be capable of communication over Long-Term Evolution (LTE), Wideband Code-Division Multiple Access (WCDMA), Universal Mobile Telecommunications Service (UMTS), Global System for Mobile communications (GSM), CDMA2000, etc. The network interface may also enable communication between objects in the environment (e.g., vehicles, mobile devices, etc.), using local area network(s), such as Bluetooth, Bluetooth Low Energy (LE), Z-Wave, ZigBee, etc., and/or Low Power Wide-Area Network(s) (LPWANs), such as Long Range Wide-Area Network (LoRaWAN), SigFox, etc.

In some examples, such as where the network strength is below a threshold, or a certain network type is not available for connection (e.g., only a 4G cellular connection is available, and 5G is preferable), only required or necessary sensor data may be transmitted to the remote control system 606 (or required or necessary sensor data may be prioritized in fitting the sensor data into network constraints). For example, during standard or normal operation, all of the sensor data may be transmitted to the remote control system 606 (e.g., sensor data from each of the sensors 610 that generate sensor data for use by the remote control system 606). However, once the network signal drops below a threshold signal strength, or once a certain network type becomes unavailable, less sensor data, such as sensor data from a subset of the sensors 610, may be transmitted.

In such examples, orientation data representative of an orientation of the VR headset 616 of the remote control system 606 may be used. For example, if the remote operator is looking toward the left-front of the virtual vehicle within the virtual environment, the sensor data from the sensor(s) 610 that have a field(s) of view of the left-front of the vehicle 602 may be determined. These sensor(s) 610 may be a left-facing camera(s), a forward-facing camera(s), a LIDAR sensor and/or RADAR sensor(s) with a field(s) of view to the left and/or front of the vehicle 602 and/or other sensor types. The orientation data may be used to inform the vehicle 602 (e.g., via one or more signals) of a subset of the sensor data that should be transmitted to the remote control system 606. As a result (e.g., based on the signal(s)), the subset of the sensor data may be encoded and transmitted across the network(s) 604 to the remote control system 606. As the remote operator continues to look around the virtual environment, updated orientation data may be generated and transmitted over the network(s) 604 to the vehicle 602, and updated subsets of the sensor data may be received by the remote control system 606. As a result, the remote operator may be presented with a field of view that includes information relevant to where the remote operator is looking, and the other portions of the virtual environment may not be streamed or rendered.

In some examples, a subset of the sensor data may be transmitted to the remote control system 606 that enables the virtual environment 656 to be rendered without providing any image data (e.g., images or video of the real-world or physical environment). For example, locations of objects, surfaces, and/or structures, as well as types of objects, surfaces, and/or structures may be determined from the sensor data, and this information may be transmitted to the remote control system 606 for generating a completely synthetic virtual environment (e.g., no images or video of the real or physical world, just a virtual world). In such an example, if it is determined a vehicle is to the left of the vehicle 602, and a person is to the right, the virtual environment may be rendered to include a vehicle and a person (e.g., generic representations) at locations that correspond to the real-world. In a more detailed example, the vehicle type of the vehicle may be determined, and the virtual environment may include a virtual representation of the vehicle type (e.g., as determined from a data store).

In other examples, a combination of a fully rendered virtual environment and image data (e.g., images or video) may be used within the virtual environment. For example, images or video may be included within the virtual environment in a field of view of the remote operator, but other portions of the virtual environment may include only virtual representations. As a result, if a remote operator changes orientation, and image data has not yet been received for the updated field of view of the remote operator, there may still be enough information within the environment (e.g., the virtual representations of the objects, surfaces, and/or structures) based on the rendering to allow the remote operator to control the vehicle 602 safely.

Although the signal strength or connection type is described as a reason for transmitting only a subset of the sensor data, this is not intended to be limiting. For example, the subset of the sensor data may be transmitted at all times, regardless of network connection strength and/or type, in order to reduce bandwidth or preserve network resources.

In some examples, once received by the remote control system 606, the sensor data (e.g., encoded sensor data) may be decoded by decoder 642 of the remote control system 606. In other examples, the encoded sensor data may be used by the virtual environment generator 614 and/or the remote control(s) 618 (e.g., for calibration) without decoding. The virtual environment generator 614 may use the sensor data to generate the virtual environment. The sensor data may include image data from camera(s), LIDAR data from LIDAR sensor(s), RADAR data from RADAR sensor(s), and/or other data types from other sensor(s) 610, such as vehicle state data and/or configuration data, as described herein. The virtual environment generator 614 may use the sensor data to generate or render the virtual environment and at least a portion of the virtual environment may be displayed on a display of the VR headset 616. Examples of the virtual environment are described in more detail herein, such as with reference to FIGS. 7A-7B.

In some examples, the virtual environment may be generated using the vehicle state data and/or the calibration data, in addition to image data, LIDAR data, SONAR data, etc. In such examples, the vehicle state data may be used to update a location and/or orientation of the virtual vehicle in the virtual environment and/or to update visual indicators of the vehicle state in the virtual environment (e.g., to update a speedometer, a revolutions per minute (RPM) display, a fuel level display, a current time where the vehicle 602 is located, an odometer, a tachometer, a coolant temperature gauge, a battery charge indicator, a gearshift indicator, a turn signal indicator, a headlight/high beam indicator, a malfunction/maintenance indicator, etc.). As a further example, the vehicle state data may be used to apply one or more rendering effects to the virtual environment, such as motion blur that is based at least in part on the velocity and/or acceleration of the vehicle 602.

In some examples, state data may be determined by the vehicle 602 for the objects and surface in the environment, and this state information may be used to generate the virtual environment (e.g., to provide visual indicators of types of objects, such as persons, vehicles, animals, inanimate objects, etc., or surfaces, such as a paved road, a gravel road, an uneven road, an even road, a driveway, a one-way street, a two-way street, etc., to provide visual indicators about objects, such as speeds of objects, directions of objects, etc., and/or other information pertaining to the environment).

The calibration data may be used to update the virtual controls (e.g., the representation of the remote control(s) 618 in the virtual environment). For an example, if the steering wheel is turned to the left, the virtual steering wheel may be rendered as turned to the left, if the wheels are turned to the right, the virtual wheels may be rendered to be turned to the right, if the windows are down, the virtual windows may be rendered to be down, if the seats are in a certain position, the virtual seats may be rendered to be in the certain positions, if the instrument panel and/or HMI display is on, at a certain light level, and/or showing certain data, the virtual instrument panel and/or HMI display may be on, at the certain light level, and/or showing the certain data in the virtual environment.

Any other examples for updating the virtual environment to reflect the vehicle 602 and/or other aspects of the real-world environment are contemplated within the scope of the present disclosure. By updating at least a portion of the virtual vehicle and/or other features of the virtual environment using the calibration data, the remote operator may have a more immersive, true-to-life, and realistic virtual environment to control the virtual vehicle within, thereby contributing to the ability of the remote operator to control the vehicle 602 in the real-world environment more safely and effectively.

At least some of the sensor data may be used by the remote control(s) 618, such as the calibration data for calibrating the remote control(s) 618. For example, similar to described herein with respect to updating the virtual environment using the calibration data, the remote control(s) 618 may be calibrated using the calibration data. In some examples, a steering component (e.g., a steering wheel, a joystick, etc.) of the remote control(s) 618 may be calibrated to an initial position that corresponds to the position of steering component 612A of the vehicle 602 at the time of transfer of the control to the remote control system 606. In another example, the steering component sensitivity may be calibrated using the calibration data, such that inputs to the steering component of the remote control(s) 618 (e.g., turning the steering wheel ×number of degrees to the left) substantially correspond to the inputs to the steering component 612A of the vehicle 602 (e.g., the resulting actuation of the vehicle 602 may correspond to turning the steering wheel of the vehicle 602 ×number of degrees to the left). Similar examples may be implemented for the acceleration component and/or the braking component of the remote control(s) to correspond to the sensitivity, degree of movement, pedal stiffness, and/or other characteristics of acceleration component 612C and braking component 612B, respectively, of the vehicle 602. In some examples, any of these various calibrations may be based at least in part on the year, make, model, type, and/or other information of the vehicle 602 (e.g., if the vehicle 602 is a Year N, Make X, Model Y, the virtual vehicle may retrieve associated calibration settings from a data store).

In some examples, the calibration data may be used calibrate the remote control(s) 618 such that the remote control(s) are scaled to the vehicle 602 (or object, such as a robot), such as where the vehicle is larger, smaller, or of a different type than the virtual vehicle. For example, the vehicle 602 or object may be a small vehicle or object (e.g., that cannot fit passengers), such as a model car or an exploratory vehicle (e.g., for navigating into tight or constrained environments, such as tunnels, beneath structures, etc.), etc., or may be a larger object, such as a bus, a truck, etc. In such examples, calibration data may be used to scale the remote control(s) 618 to that of the smaller, larger, or different type of object or vehicle. For example, providing an input to the steering component of the remote control(s) 618, such as by turning a steering wheel 10 degrees, may be scaled for a smaller vehicle to 2 degrees, or for a larger vehicle, to 20 degrees. As another example, the braking component of the remote control(s) 618 may correspond to anti-skid braking control inputs, but the vehicle 602 or object, especially when small, may use skid braking. In such examples, the remote control(s) may be calibrated such that inputs to the braking component of the remote control(s) is adjusted for skid braking.

The scaling may additionally, or alternatively, be performed on the outputs of the remote control(s) (e.g., the control data). For example, after the control inputs to the remote control(s) 618, the control inputs may be scaled to correspond to the control(s) of the smaller, larger, or different type of vehicle 602 or object. This may allow the remote operator to control the virtual vehicle or object using the remote control(s) 618 in a way that feels more natural to the remote operator, but while calibrating or scaling the control data representative of the control inputs for the vehicle 602 or other object to correspond to the vehicle control data that is useable for the vehicle 602 or other object. In some examples, this may be performed by the encoder 644 of the remote control system 606, and/or by another component.

In any example, prior to transmission of the control data to the vehicle 602, the control data may be encoded by the encoder 644. The encoded control data may be in a format that is useable to the vehicle (e.g., the control data from the remote control(s) 618 may be encoded to generate vehicle control data that is useable by the vehicle 602). In other examples, the control data may be transmitted to the vehicle 602 over the network(s) 604 using the communication components 640 and 636, and the vehicle 602 may encode the control data to generate the vehicle control data. As such, the control data from the remote control(s) 618 may be converted to the vehicle control data prior to transmission by the remote control system 606, after receipt by the vehicle 602, or a combination thereof.

The control data, in some examples, may be received by the communication component 636 of the vehicle 602 and decoded by the decoder 638. The vehicle control data may then be used by at least one of the layers of the drive stack 608 or may bypass the drive stack 608 (e.g., where full control is transferred to the remote control system 606 and the vehicle 602 exits self-driving or autonomous mode completely) and be passed directly to the control components of the vehicle 602, such as the steering component 612A, the braking component 612B, the acceleration component 612C, and/or other components (e.g., a blinker, light switches, seat actuators, etc.). As such, the amount of control given to the remote control system 606 may include from no control, full control, or partial control. The amount of control of the autonomous vehicle 602 may inversely correspond to the amount of control given to the remote control system 606. Thus, when the remote control system 606 has full control, the autonomous vehicle 602 may not execute any on-board control, and when the remote control system 606 has no control, the autonomous vehicle 602 may execute all on-board control.

In examples where the vehicle control data (e.g., corresponding to the control data generated based on control inputs to the remote control(s) 618) is used by the drive stack 608, there may be different levels of use. In some examples, only the obstacle avoidance component(s) 630 may be employed. In such examples, the vehicle control data may be analyzed by the obstacle avoidance component(s) 630 to determine whether implementing the controls corresponding to the vehicle control data would result in a collision or an otherwise unsafe or undesirable outcome. When a collision or unsafe outcome is determined, the vehicle 602 may implement other controls (e.g., controls that may be similar to the controls corresponding to the vehicle control data but that decrease, reduce, or remove altogether the risk of collision or other unsafe outcome). In the alternative, the vehicle 602 may implement a safety procedure when a collision or other unsafe outcome is determined, such as by coming to a complete stop. In these examples, the control inputs from the remote control(s) 618 may be associated (e.g., one-to-one) with the controls of the vehicle 602 (e.g., the control inputs to the remote control(s) 618 may not be suggestions for control of the vehicle, such as waypoints, but rather may correspond to controls that should be executed by the vehicle 602).

As described herein, the control inputs from the remote control(s) 618 may not be direct or one-to-one controls for the vehicle 602, in some examples. For example, the control inputs to the remote control(s) 618 may be suggestions. One form of suggestion may be an actual input to a steering component, an acceleration component, a braking component, or another component of the remote control(s) 618. In such an example, the vehicle control data corresponding to these control inputs to the remote control(s) 618 may be used by the drive stack 608 to determine how much, or to what degree, to implement the controls. For example, if the remote operator provides an input to a steering component of the remote control(s) 618 (e.g., to turn a steering wheel 10 degrees), the planning component(s) 626 and/or the control component(s) 628 of the drive stack 608 may receive the vehicle control data representative of the input to the steering component, and determine to what degree to turn to the left (or to not turn left at all). The drive stack 608 may make a determination to turn left, for example, but may determine that a more gradual turn is safer, follows the road shape or lane markings more accurately, and/or otherwise is preferable over the rate of the turn provided by the remote operator (e.g., the 10 degree turn of the steering wheel). As such, the vehicle control data may be updated and/or new vehicle control data may be generated by the drive stack 608, and executed by the steering component 612A of the vehicle 602 (e.g., based at least in part on a command or signal from the actuation component(s) 632).

Similar use of the vehicle control data may be performed based at least in part on inputs to the acceleration component, braking component, and/or other components of the remote control(s) 618. For example, an input to an acceleration component of the remote control(s) 618 may cause an acceleration by the acceleration component 612C of the vehicle 602, but the acceleration rate may be less, more, or zero, depending on the determination(s) by the drive stack 608. As another example, an input to a braking component of the remote control(s) 618 may cause a braking by the braking component 612B of the vehicle 602, but the deceleration rate may be less, more, or zero, depending on the determination(s) by the drive stack 608.

Another form of suggestions from the remote control(s) 618 may be waypoint suggestions. For example, the remote operator may use a remote control 618 that is a pointer (e.g., a virtual laser pointer), and may point to virtual locations in the virtual environment that the virtual vehicle is to navigate to (e.g., a virtual waypoint). The real-world locations in the real-world environment that correspond to the virtual locations in the virtual environment may be determined, and the vehicle control data may represent the real-world locations (e.g., the real-world waypoints). As such, the drive stack 608, such as the planning component(s) 626 and/or the control component(s) 628, may use the real-world waypoint to determine a path and/or control(s) for following the path to reach the real-world waypoint. The actuation component(s) 632 may then cause the steering component 612A, the braking component 612B, the acceleration component 612C, and/or other components of the vehicle 602 to control the vehicle 602 to travel to the real-world location corresponding to the real-world waypoint. The remote operator may continue to provide these control inputs to navigate the vehicle 602 through the situation, scenario, and/or environment that necessitated the transfer of at least partial control to the remote control system 606.

Now referring to FIGS. 7A-2B, FIGS. 7A-7B illustrate examples of virtual environments that may be generated by the virtual environment generator 614. In one or more embodiments, the virtual environments may be displayed on a display of the VR headset 616. Alternatively, the virtual environments may be displayed on a display corresponding to a physical representation of a vehicle. The physical representation may include any configuration of control (e.g., a steering wheel, one or more accelerators or brakes, one or more transmission controls), seating, or visibility (e.g., one or more displays positioned as mirrors) features corresponding to physical, real-world counterparts in an ego-vehicle. Virtual environment 700 of FIG. 7A may include a virtual environment where an exterior of a vehicle 702 is rendered, such that a field of view of the remote operator includes the exterior of the vehicle 702. In one or more embodiments, the vehicle 702 may be presented as a virtually simulated vehicle. Alternatively, the virtual environment 700 may be rendered in one or more displays positioned around a partially or completely physical vehicle 702 calibrated to correspond to the ego-vehicle. In the cases where the vehicle 702 comprises a virtual vehicle, the virtual vehicle 702 may be rendered on a surface 704 of the virtual environment 700. In this case, the surface 704 may be one of any number of suitable surfaces, such as a representation of a garage floor, a laboratory floor, etc. However, this is not intended to be limiting, and in some examples, the surface 704 may be rendered to represent the surface the vehicle 602 is on in the real-world environment (e.g., using sensor data generated from cameras with a field(s) of view of the surface around the vehicle 602, such as a parking camera(s)).

The sensor data, such as image data, representative of a field(s) of view of the sensor(s) 610 may be displayed within the virtual environment 700 on one or more virtual displays 706, such as the virtual displays 706A, 706B, 706C, and/or addition or alternative virtual displays 706. In some examples, the virtual display(s) 706 may be rendered to represent up to a 360 degree field of view of the sensor(s) 610 of the vehicle 602. As described herein, the surface 704 and/or an upper portion 708 of the virtual environment 700 may also be rendered to represent the real-world environment of the vehicle 602. The upper portion 708 may include buildings, trees, the sky, and/or other features of the real-world environment, such that the virtual environment 700 may represent a fully immersive environment. The surface 704 and/or the upper portion 708, similar to the virtual display(s) 706, may include images or video from image data generated by the vehicle 602, may include rendered representations of the environment as gleaned from the sensor data (e.g., image data, LIDAR data, RADAR data, etc.), or a combination thereof.

The instance of the virtual environment 700 illustrated in FIG. 7A may represent the scenario represented in the image 646. For example, the virtual display 706B may include the virtual representations of the van 652, the boxes 654, the street 648, and/or other features of the image 646. The virtual representations of the image data may include the images or video from the image data, rendered within the virtual environment 700. As such, the images or video displayed on the virtual displays 706 may be the actual images or video (e.g., not a virtual representation thereof). In other examples, the images or video displayed on the virtual displays 706 may be a rendered representation of the environment, which may be generated from the sensor data (e.g., the image data, the LIDAR data, the SONAR data, etc.).

As described herein, the vehicle state data and/or the calibration data may be used to generate the virtual environment. In such examples, wheels 710 of the virtual vehicle 702 may be rendered at approximately the wheel angle of the wheels of the vehicle 602 in the real-world environment. In this illustration, the wheels may be straight. Similarly, lights may be turned on or off, including brake lights when braking, emergency lights when turned on, etc. When the vehicle 702 includes a physical, tangible representation, the vehicle state data and/or the calibration data of the ego-vehicle may be used to calibrate and orient the physical representation vehicle 702.

When controlling a virtual vehicle 702 implemented as a virtual vehicle in the virtual environment 700, or other virtual environments where the vantage point of the remote operator is outside of the virtual vehicle 702, the remote operator may be able to move around the virtual environment 700 freely to control the virtual vehicle 702 from different vantage points (or may be able to change the vantage point to inside the virtual vehicle, as illustrated in FIG. 7B). For example, the remote operator may be able to sit on top of or above the virtual vehicle 702, to the side of the virtual vehicle 702, in front of the virtual vehicle 702, behind the virtual vehicle 702, etc.

In examples where the remote operator provides virtual waypoints rather than actual controls, a vantage point outside of the virtual vehicle 702 may be more useful. For example, the remote operator may have a vantage point from on top of the virtual vehicle 702, such as at location 712 within the virtual environment 700, and may use device 714 (e.g., a virtual pointer, a virtual laser, etc.) to identify a location within the virtual environment 700 and/or a location within the image data represented within the virtual environment 700, such as location 716. When the location 716 corresponds to the image data, such as a point(s) or pixel(s) within the image data, the real-world coordinates corresponding to the point(s) or the pixel(s) may be determined (e.g., by the vehicle 602 and/or the remote control system 606). For example, the camera(s) that captured the image data may be calibrated such that transformations from two-dimensional locations of the point(s) or the pixel(s) within the image data to three-dimensional points in the real-world environment may be computed or known. As a result, the virtual way-points (e.g., the location 716) identified within the virtual environment 700 by the remote operator may be used to determine real-world locations (e.g., corresponding to the location 716) for the vehicle 602 to navigate to. As described herein, the vehicle 602 may use this information to determine the path, controls, and/or actuations that will control the vehicle 602 to the real-world location.

As the vehicle 602 is controlled through the real-world environment, the virtual display(s) 706 may be updated to reflect the updated sensor data over time (e.g., at the frame rate that the sensor data is captured, such as 30 frames per second (“fps”), 60 fps, etc.). As the (virtual) vehicle 702 is being controlled, the wheels, lights, windows, blinkers, etc., may be updated according to the corresponding features on the vehicle 602 in the real-world environment.

Now referring to FIG. 7B, the virtual environment 656 may be the same virtual represent 656 of FIG. 6A, described herein. Although the vantage point illustrated in FIG. 7B is from a left-side driver's seat within the virtual vehicle, this is not intended to be limiting. For example, and without departing from the scope of the present disclosure, the remote operator may have a vantage point from the position a right-side driver's seat (e.g., for jurisdictions where driving is on the left side of the road), a passenger's seat, a back seat, an imaginary seat (e.g., a middle-driver's seat), or from a vantage point within the virtual vehicle not corresponding to a seat, such as from anywhere within the virtual vehicle.

As described herein, one or more of the features of the virtual vehicle may be made at least partially transparent and/or may be removed from the rendering of the virtual vehicle. For example, certain portions of a real-world vehicle (alternatively referred to herein as “ego-vehicle” or “physical vehicle”) may be used for structural support, but may cause occlusions for a driver (e.g., “blind spots). In a virtual vehicle, this need for structural support is non-existent, so portions of the virtual vehicle that may be visually occluding may be removed and/or made at least partially transparent in the virtual environment 656. For example, the support column 666, and/or other support columns of the virtual vehicle, may be made transparent (as illustrated in FIG. 7B) or may be removed completely from the rendering. In other examples, doors 722 may be made transparent (e.g. but for an outline) or entirely removed. As a result, the remote operator may be presented with a field(s) of view that is more immersive, with less occlusions, thereby facilitating more informed, safer control.

In addition, a portion(s) of the virtual vehicle may be made at least partially transparent or be removed even where the portion(s) of the virtual vehicle does not cause occlusions, in order to allow the remote operator to visualize information about the virtual vehicle (and thus the vehicle 602) that would not be possible in a real-world environment. For example, a portion of the virtual vehicle between a vantage point of the remote operator and one or more of the wheels and/or tires of the vehicle may be made at least partially transparent or may be removed from the rendering, such that the remote operator is able to visualize an angle of the wheel(s) and/or the tire(s) (e.g., where the wheels and/or tires are at the angle based on the calibration data).

The virtual environment 656 may include, in addition to or alternatively from the features described herein with respect to FIG. 6A, a virtual instrument panel 718, virtual side-view or wing-mirrors 720, and/or other features. The virtual instrument panel 718 may display any number of different information, such as, without limitation, a speedometer, a fuel level indicator, an oil pressure indicator, a tachometer, an odometer, turn indicators, gearshift position indicators, seat belt warning light(s), parking-brake warning light(s), engine-malfunction light(s), airbag (SRS) system information, lighting controls, safety system controls, navigation information, etc. The virtual side-view or wing-mirrors 720 may display sensor data captured by one or more sensor(s) 610 (e.g., camera(s)) of the vehicle 602 with a field(s) of view to the rear and/or to the side of the vehicle 602 (e.g., to represent a side-view or wing-mirror of the vehicle 602).

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving, using a remote system and from a machine, first data representative of an environment for which the machine is navigating;
determining, using the remote system and based at least on input data representing one or more inputs to one or more input devices, an action associated with navigating the machine within the environment;
determining, using the remote system and based at least on the first data, that the action satisfies one or more policies associated with safely navigating the machine; and
based at least on the action satisfying the one or more policies, sending, using the remote system and to the machine, second data representative of a command to perform the action.

2. The method of claim 1, wherein the determining the action associated with navigating the machine within the environment comprises:
determining, based at least on the input data, a plan associated navigating the machine within the environment; and
determining, using one or more machine learning models and based at least on the plan and the first data, the action associated with navigating the machine within the environment.

3. The method of claim 1, wherein the determining the action associated with navigating the machine within the environment comprises:
determining, based at least on the input data, a plan associated with navigating the machine within the environment; and
determining, using one or more machine learning models and based at least on the plan and the first data, at least one of one or more paths that the machine may navigate within the environment to perform the plan or one or more controls that the machine may use to perform the plan, the at least one of the one or more paths or the one or more controls associated with the action.

4. The method of claim 1, further comprising:
determining, using the machine and based at least on sensor data generated using one or more sensors of the machine, that the action satisfies one or more second policies associated with navigating the machine within the environment; and
based at least on the action satisfying the one or more second policies, causing the machine to perform the action within the environment.

5. The method of claim 4, wherein:
the one or more policies are associated with determining whether the action is viable based at least on the environment; and
the one or more second policies are associated with determining whether the action may cause the machine to collide with one or more objects within the environment.

6. The method of claim 1, further comprising:
determining, using the machine, one or more controls for causing the machine to perform the action within the environment; and
causing, based at least on the one or more controls, the machine to navigate according to the action within the environment.

7. The method of claim 1, further comprising:
determining that one or more faults associated with at least one of the machine, the remote system, or a network connection between the machine and the remote system have occurred;
based at least on the one or more faults occurring, determining, using the machine based at least on sensor data generated using one or more sensors of the machine, a second action associated with navigating the machine within the environment; and
causing the machine to perform the second action within the environment.

8. The method of claim 1, further comprising:
generating, using the remote system and based at least on the first data, a virtual scene representative of the environment surrounding the machine; and
causing, using the remote system, an output associated with the virtual environment,
wherein the determining the action associated with navigating the machine within the environment occurs during the output associated with the virtual environment.

9. The method of claim 1, wherein:
the machine includes at least:
a first scene component for generating a virtual environment based at least on the first data;
a first planning component for the determining the action based at least on the input data;
a first policy component for the determining that the action satisfies the one or more policies based at least on the first data; and
a first action component for generating the command associated with the action; and
the machine includes at least:
a second scene component for generating a representation of a real-world environment based at least on sensor data;
a second planning component for interpreting the action;
a second policy component for determining that the action satisfies one or more second policies; and
a second action component for causing the vehicle to navigate according to the action.

10. A system comprising:
a control system to:
determine an action associated with navigating a machine within an environment;
determine that the action satisfies one or more first policies associated with safely navigating the machine within the environment; and
based at least on the action satisfying the one or more first policies, send, to the machine, data representing the action; and
the machine to:
determine that the action satisfies one or more second policies associated with safely navigating the machine within the environment; and
based at least on the action satisfying the one or more second policies, cause the machine to perform the action within the environment.

11. The system of claim 10, wherein:
the one or more first policies are associated with determining whether the action is viable based at least on the environment; and
the one or more second policies are associated with determining whether the action may cause the machine to collide with one or more objects within the environment.

12. The system of claim 10, wherein the control system is further to:
receive, from the machine, second data representative of the environment;
cause, based at least on the second data, an output of a virtual representative of the environment; and
receive, during the output of the virtual environment, input data representing of one or more input,
wherein the determination of the action associated with navigating the machine within the environment is based at least on the input data.

13. The system of claim 12, wherein the determination of the action associated with navigating the machine within the environment comprises:
determining, based at least on the input data, a plan for navigating the machine within the environment; and
determining, using one or more machine learning models and based at least on the plan and the second data, the action associated with navigating the machine within the environment.

14. The system of claim 10, wherein the machine is further to:
determine one or more controls for causing the machine to perform the action within the environment,
wherein the machine is caused to perform the action within the environment based at least on the one or more controls.

15. The system of claim 10, wherein the machine is further to:
generate sensor data using one or more sensors, the sensor data representative of the environment,
wherein the determination that the action satisfies the one or more second policies associated with safely navigating the machine within the environment is based at least on the sensor data.

16. The system of claim 10, wherein the machine is further to:
determine that one or more faults associated with at least one of the machine, the control system, or a network connection between the machine and the control system have occurred;
based at least on the one or more faults occurring, determine, based at least on sensor data generated using one or more sensors of the machine, a second action associated with navigating the machine within the environment; and
causing the machine to perform the second action within the environment.

17. The system of claim 10, wherein the system is comprised in at least one of:
a control system for an autonomous or semi-autonomous machine;
a perception system for an autonomous or semi-autonomous machine;
a system for performing simulation operations;
a system for performing teleoperation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implementing one or more large language models (LLMs);
a system for performing conversational AI operations;
a system for generating synthetic data;
a system incorporating one or more virtual machines (VMs);
a system implemented at least partially in a data center; or
a system implemented at least partially using cloud computing resources.

18. A processor comprising:
one or more processing units to send, to a machine, first data representative of an action for the machine to perform within an environment, wherein the action is determined based at least on input data representative of one or more inputs and verified to satisfy one or more safety policies based at least on second data received from the machine.

19. The processor of claim 18, wherein the one or more processing units are further to:
cause, based at least on the second data, an output of a virtual environment associated with the environment;
receive, while the virtual environment is being output, the input data representative of the one or more inputs; and
determine, using one or more machine learning models and based at least on the input data, the action for the machine to perform within the environment.

20. The processor of claim 18, wherein the system is comprised in at least one of:
a control system for an autonomous or semi-autonomous machine;
a perception system for an autonomous or semi-autonomous machine;
a system for performing simulation operations;
a system for performing teleoperation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implementing one or more large language models (LLMs);
a system for performing conversational AI operations;
a system for generating synthetic data;
a system incorporating one or more virtual machines (VMs);
a system implemented at least partially in a data center; or
a system implemented at least partially using cloud computing resources.
